(19) United States
(12) Patent Application Publication
(10) Pub. No.: US 2014/0023343 A1
(43) Pub. Date: Jan. 23, 2014

(54) VIDEO PROCESSING SYSTEM AND VIDEO PROCESSING METHOD, VIDEO PROCESSING APPARATUS, CONTROL METHOD OF THE APPARATUS, AND STORAGE MEDIUM STORING CONTROL PROGRAM OF THE APPARATUS

(71) Applicants: Hiroo Harada, Tokyo (JP); Naotake Fujita, Tokyo (JP)

(72) Inventors: Hiroo Harada, Tokyo (JP); Naotake Fujita, Tokyo (JP)

(73) Assignee: NEC CORPORATION, Minato-ku, Tokyo (JP)

(21) Appl. No.: 14/007,371

(22) PCT Filed: Jan. 30, 2012
(86) PCT No.: PCT/JP2012/051925

§ 371 Date: Sep. 25, 2013

(30) Foreign Application Priority Data
Mar. 25, 2011 (JP) 2011-067640

(51) Int. Cl. H04N 9/79

(52) U.S. Cl. CPC H04N 9/79
USPC 386/242

(57) ABSTRACT

A system of this invention is a video processing system for detecting a change of a capturing target based on a video whose capturing range changes. This video processing system includes a capturing unit that captures the video whose capturing range changes, a feature extractor that extracts a frame feature of each frame from the captured video, a feature storage that stores, for each frame, the frame feature extracted by the feature extractor, a frame searcher that searches for a frame, a frame feature of which is stored in the feature storage, having a capturing range matching that of the newly captured frame by comparing a frame feature of a newly captured frame with the frame features stored in the feature storage, and a change detector that detects a change of the capturing target based on a difference between the frame feature of the newly captured frame and the frame feature of the frame found by the frame searcher. With this arrangement, it is possible to detect a change of a capturing target even if the capturing range of a capturing apparatus changes every moment.

### TECHNICAL FIELD

The present invention relates to a video processing technique of monitoring a video obtained by a capturing apparatus.

### BACKGROUND ART

In the above-described technical field, patent literature 1 discloses detecting a moving object, for example, an intruder from the feature of the difference image between a first image and a second image which are captured by a monitoring camera at a time interval of several sec. In addition, patent literature 2 discloses segmenting images obtained from a monitoring camera into meshes and performing abnormality determination based on the feature of the difference image of each mesh.

### CITATION LIST

### Patent Literature

Patent literature 1: Japanese Patent Laid-Open No. 6-294808
Patent literature 2: Japanese Patent Laid-Open No. 2003-087773

### SUMMARY OF THE INVENTION

### Technical Problem

However, both techniques described in the above literatures detect an abnormality in a monitoring target based on a video obtained by a fixed monitoring camera. It is impossible to detect a change of a capturing target if the capturing range of the capturing apparatus changes every moment due to panning, zooming, or the like.

The present invention enables to provide a technique of solving the above-described problem.

### Solution to Problem

One aspect of the present invention provides a video processing system for detecting a change of a capturing target based on a video whose capturing range changes, comprising:

a capturing unit that captures the video whose capturing range changes;

a feature extractor that extracts a frame feature of each frame from the captured video;

a feature storage that stores the frame feature of the each frame extracted by the feature extractor;

a frame searcher that searches for a frame, a frame feature of which is stored in the feature storage, having a capturing range matching a capturing range of the newly captured frame by comparing a frame feature of a newly captured frame with the frame features stored in the feature storage; and

a change detector that detects a change of the capturing target based on a difference between the frame feature of the newly captured frame and the frame feature of the frame found by the frame searcher.

Another aspect of the present invention provides a video processing method of detecting a change of a capturing target based on a video whose capturing range changes, comprising the steps of:

capturing the video whose capturing range changes;

extracting a frame feature of each frame from the captured video;

storing the frame feature of the each frame extracted in the extracting step into a feature storage;

searching for a frame, a frame feature of which is stored in the feature storage, having a capturing range matching a capturing range of the newly captured frame by comparing a frame feature of a newly captured frame with the frame features stored in the feature storage; and

detecting a change of the capturing target based on a difference between the frame feature of the newly captured frame and the frame feature of the frame found in the searching for the frame.

Still other aspect of the present invention provides a video processing apparatus for detecting a change of a capturing target based on a video captured by a capturing unit whose capturing range changes, comprising:

a feature storage that stores a frame feature of each frame extracted from the captured video;

a frame searcher that searches for a frame, a frame feature of which stored in the feature storage, having a capturing range matching a capturing range of the newly captured frame by comparing a frame feature of a newly captured frame with the frame features stored in the feature storage;

a change detector that detects a change of the capturing target based on a difference between the frame feature of the newly captured frame and the frame feature of the frame found by the frame searcher; and

a video accumulator that accumulates the video detected by the change detector in which the capturing target changes.

Still other aspect of the present invention provides a control method of a video processing apparatus for detecting a change of a capturing target based on a video captured by a capturing unit whose capturing range changes, comprising the steps of:

storing a frame feature of each frame extracted from the captured video into a feature storage;

searching for a frame, a frame feature of which is stored in the feature storage, having a capturing range matching that of the newly captured frame by comparing a frame feature of a newly captured frame with the frame features stored in the feature storage;

detecting a change of the capturing target based on a difference between the frame feature of the newly captured frame and the frame feature of the frame found in the searching step; and

accumulating a plurality of frames including the frame where the capturing target has changed, which is detected in the detecting step.

Still other aspect of the present invention provides a computer-readable storage medium storing a control program of a video processing apparatus for detecting a change of a capturing target based on a video captured by a capturing unit whose capturing range changes, the control program causing a computer to execute the steps of:

storing a frame feature of each frame extracted from the captured video into a feature storage;

searching for a frame, a frame feature of which is stored in the feature storage, having a capturing range matching a capturing range of the newly captured frame by comparing a frame feature of a newly captured frame with the frame features stored in the feature storage;

detecting a change of the capturing target based on a difference between the frame feature of the newly captured frame and the frame feature of the frame found in the searching step; and

accumulating a plurality of frames including the frame where the capturing target has changed, which is detected in the detecting step.

Still other aspect of the present invention provides a capturing apparatus that includes a moving unit changing a capturing range and captures a video whose capturing range changes, comprising:

a capturing unit whose capturing range changes;

a feature extractor that extracts a frame feature of each frame from the video captured by the capturing unit; and

a selector that selects a video in which a capturing target changes in a same capturing range based on the frame features extracted by the feature extractor.

Still other aspect of the present invention provides a control method of a capturing apparatus that includes a moving unit changing a capturing range and captures a video whose capturing range changes, comprising the steps of:

extracting a frame feature of each frame from the video captured by a capturing unit whose capturing range changes; and

selecting a video in which a capturing target changes in a same capturing range based on the frame features extracted in the extracting step.

Still other aspect of the present invention provides a computer-readable storage medium storing a control program of a capturing apparatus that includes a moving unit changing a capturing range and captures a video whose capturing range changes, the control program causing a computer to execute the steps of:

extracting a frame feature of each frame from the video captured by a capturing unit whose capturing range changes; and

selecting a video in which a capturing target changes in a same capturing range based on the frame features extracted in the extracting step.

### Advantageous Effects of Invention

According to the present invention, it is possible to detect a change of a capturing target even if a capturing range of a capturing apparatus changes every moment.

### BRIEF DESCRIPTION OF THE DRAWINGS

FIG. 1 is a block diagram showing the arrangement of a video processing system according to the first embodiment of the present invention;

FIG. 2 is a block diagram showing the arrangement of a video processing system according to the second embodiment of the present invention;

FIG. 3A is a block diagram showing the arrangement of a frame feature extractor according to the second embodiment of the present invention;

FIG. 3B is a view showing processing of the frame feature extractor according to the second embodiment of the present invention;

FIG. 3C is a view showing the extraction regions of the frame feature extractor according to the second embodiment of the present invention;

FIG. 4 is a view showing the arrangement of a frame feature DB according to the second embodiment of the present invention;

FIG. 5 is a view showing the arrangement and processing of a frame searcher according to the second embodiment of the present invention;

FIG. 6 is a view showing the arrangement and processing of a change detector according to the second embodiment of the present invention;

FIG. 7 is a view showing the arrangement of a video accumulation DB according to the second embodiment of the present invention;

FIG. 8 is a block diagram showing the hardware arrangement of a video processing apparatus according to the second embodiment of the present invention;

FIG. 9 is a flowchart showing the processing procedure of the video processing apparatus according to the second embodiment of the present invention;

FIG. 10 is a block diagram showing the arrangement of a video processing system according to the third embodiment of the present invention;

FIG. 11 is a block diagram showing the arrangement of a video processing system according to the fourth embodiment of the present invention;

FIG. 12 is a block diagram showing the arrangement of a video processing system according to the fifth embodiment of the present invention;

FIG. 13 is a block diagram showing the arrangement of a video processing system according to the sixth embodiment of the present invention;

FIG. 14 is a block diagram showing the arrangement of a video processing system according to the seventh embodiment of the present invention;

FIG. 15A is a view showing the arrangement and operation of a moving period detector according to the seventh embodiment of the present invention;

FIG. 15B is a flowchart showing the control procedure of the moving period detector according to the seventh embodiment of the present invention;

FIG. 16 is a flowchart showing the control procedure of a video processing apparatus according to the seventh embodiment of the present invention;

FIG. 17 is a block diagram showing the arrangement of a video processing system according to the eighth embodiment of the present invention; and

FIG. 18 is a view showing the arrangement of a table provided in a moving period corrector according to the eighth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

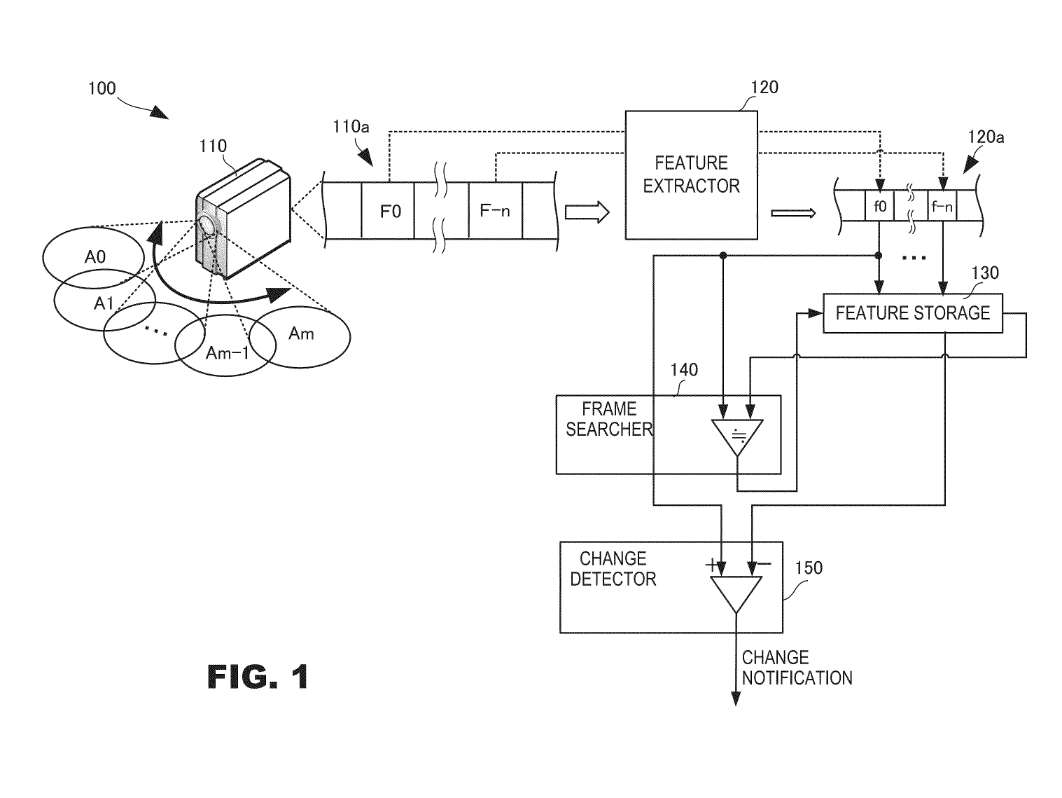

A video processing system 100 according to the first embodiment of the present invention will be described with reference to FIG. 1. The video processing system 100 detects a change of a capturing target based on a video whose capturing range changes.

As shown in FIG. 1, the video processing system 100 includes a capturing unit 110, a feature extractor 120, a feature storage 130, a frame searcher 140, and a change detector 150. The capturing unit 110 captures a video whose capturing range changes. The feature extractor 120 extracts a frame feature 120a of each frame from a captured video 11a. The feature storage 130 stores, for each frame, the frame feature 120a extracted by the feature extractor 120. The frame searcher 140 compares the frame feature 120a of a newly captured frame with the frame features stored in the feature storage 130 and thus searches for a frame stored in the feature storage 130 which has a capturing range matching that of the newly captured frame. The change detector 150 detects a change of the capturing target based on the difference between the frame feature 120a of the newly captured frame and the frame feature found by the frame searcher 140.

According to this embodiment, it is possible to detect a change of the capturing target even if the capturing range of the capturing apparatus changes every moment.

### Second Embodiment

In a video processing system according to the second embodiment of the present invention, a video processing apparatus extracts a frame feature for a video from a capturing apparatus, searches based on the frame feature for a frame to be compared, and detects a change of the capturing target from the frame feature difference between frames. The video processing apparatus notifies the detected change in the capturing target and records a video of a predetermined length including the frame where the change is detected. According to this embodiment, it is possible to detect a change of the capturing target even if the capturing range of the capturing apparatus changes every moment and also decrease the amount of the recorded video because recording only a portion where the change is detected suffices. In addition, according to this embodiment, a change in the luminance or color throughout the frames is prevented from affecting the frame feature. It is therefore possible to avoid video recording that occurs upon false recognition of darkening by evening sunlight or sunset as a change of the capturing target or false recognition of a long-term variation such as a seasonal fluctuation as a change of the capturing target, and thus reduce the storage capacity.

<Arrangement of Video Processing System>

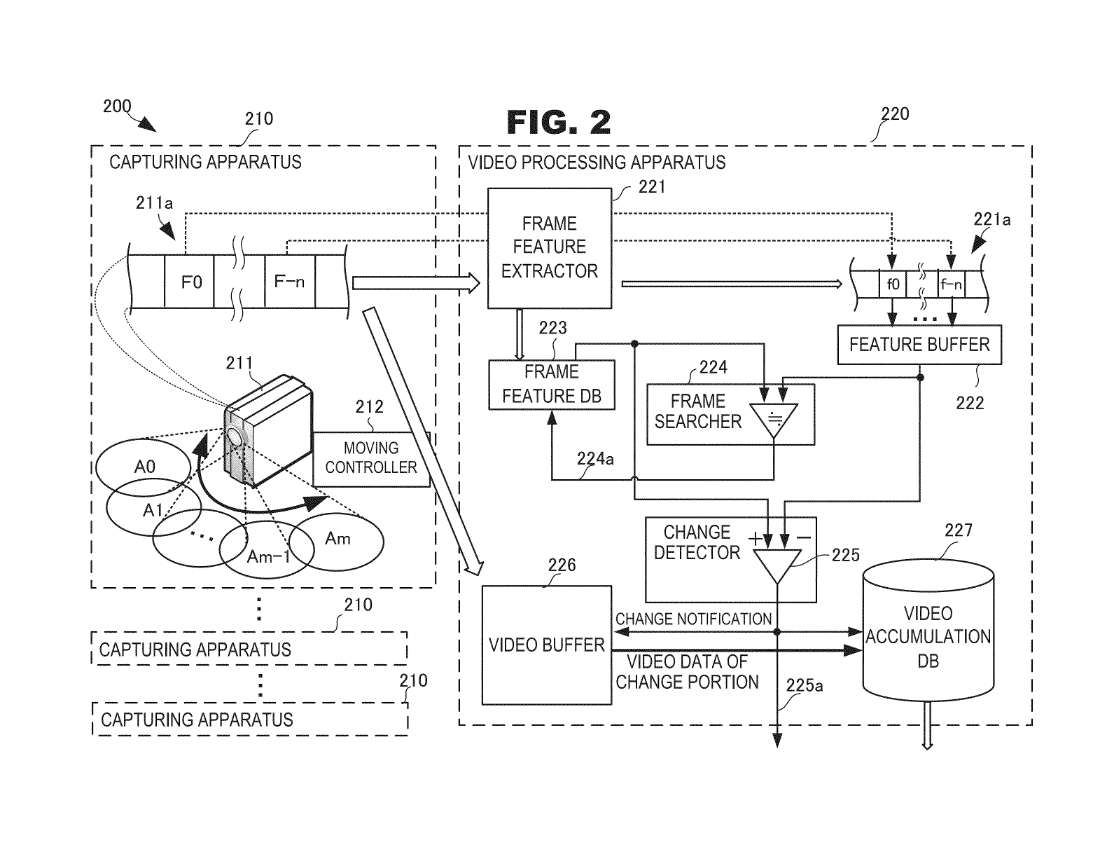

FIG. 2 is a block diagram showing the arrangement of a video processing system 200 according to this embodiment. The video processing system 200 includes at least one capturing apparatus 210, and a video processing apparatus 220 that acquires a video captured by the capturing apparatus 210, extracts a frame feature, and detects a change of the capturing target.

The capturing apparatus 210 includes a moving controller 212, and a video camera 211 that changes the capturing range while being moved by the moving controller 212. FIG. 2 illustrates panning as the movement. The video camera 211 sequentially captures capturing ranges A0 to Am, and outputs frame images F-n to F0 to the video processing apparatus 220 as video frames 211a.

In the video processing apparatus 220, a frame feature extractor 221 extracts a frame feature 221a of each frame from the input video frame 211a. The frame feature extractor 221 accumulates the frame features in a frame feature DB 223 and also temporarily stores them in a feature buffer 222. Note that the feature buffer 222 has a capacity to store the frame feature of at least one frame. Actually, the feature buffer 222 preferably has a capacity to store the frame features of a plurality of frames to raise the frame search accuracy of a frame searcher 224. The frame searcher 224 searches for a frame having a difference between the frame features smaller than a first threshold as a frame having a similar background by comparing a preceding frame feature accumulated in the frame feature DB 223 with a newly generated frame feature or frame feature sequence stored in the feature buffer 222. Upon finding a frame having a similar background, the frame searcher 224 outputs a signal 224a to the frame feature DB 223. A change detector 225 calculates the difference between the frame feature of the capturing target in the frame having a similar background from the frame feature DB 223 and the frame feature of the capturing target in the newly input frame, and detects a change if the difference is larger than a second threshold. The change detector 225 notifies, for example, an external observer of the detected change by a change detection signal 225a, and also accumulates, in a video accumulation DB 227, a video of a predetermined length including the frame where the change is detected from the video temporarily stored in a video buffer 226. Notification to the observer may include video transmission.

Note that FIG. 2 and following block diagrams of the video processing system include a transmission controller that performs video data transmission and frame feature transmission on the capturing apparatus side and a reception controller that performs video data reception and frame feature reception on the video processing apparatus side, although they are not illustrated to avoid complexity.

Suitable arrangements and operations of the above-described functional components of the video processing apparatus 220 according to this embodiment will be described below. Note that the functional components of the video processing apparatus 220 are not limited to the following examples, and various known arrangements are applicable.

(Arrangement and Processing of Frame Feature Extractor)

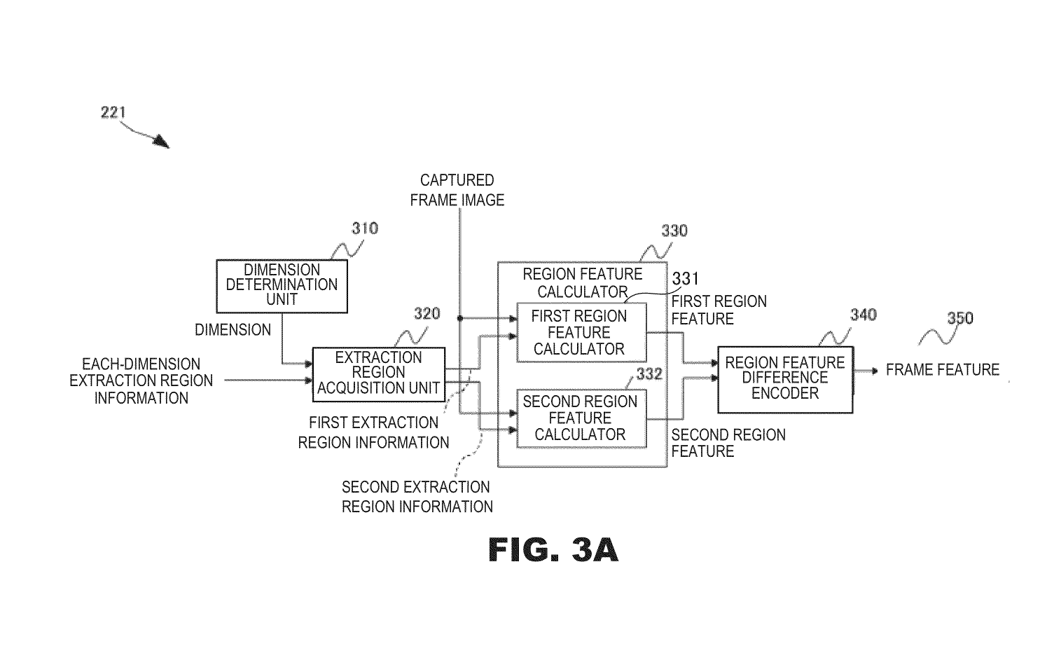

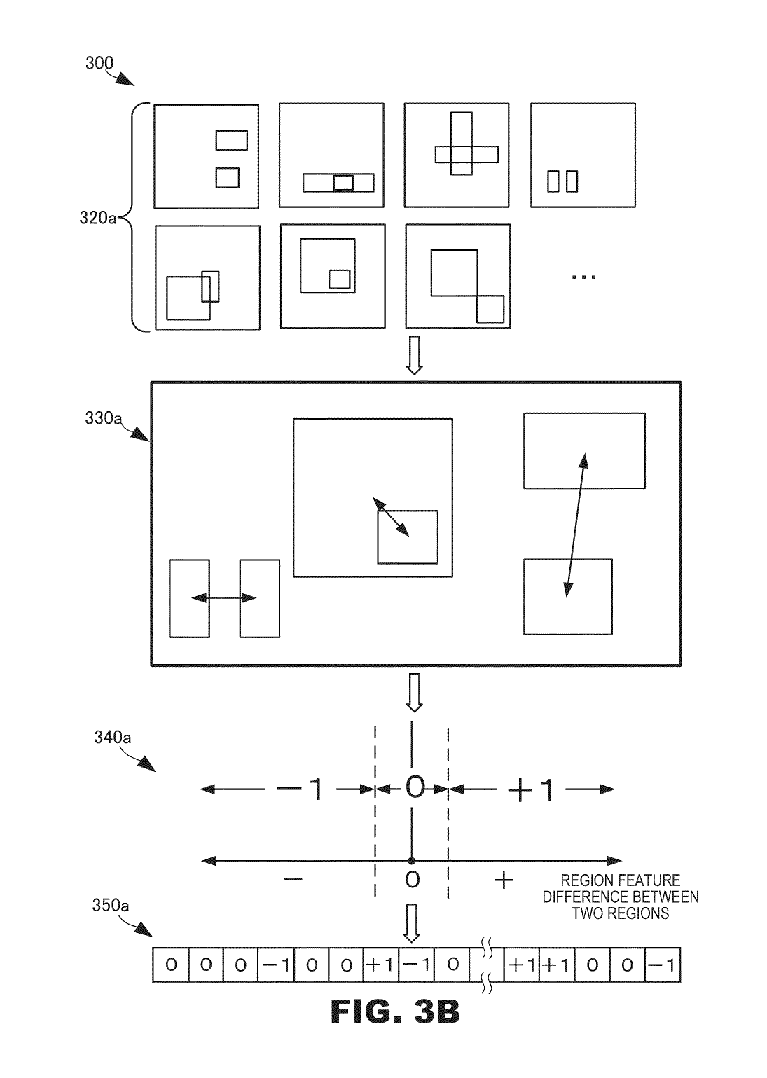

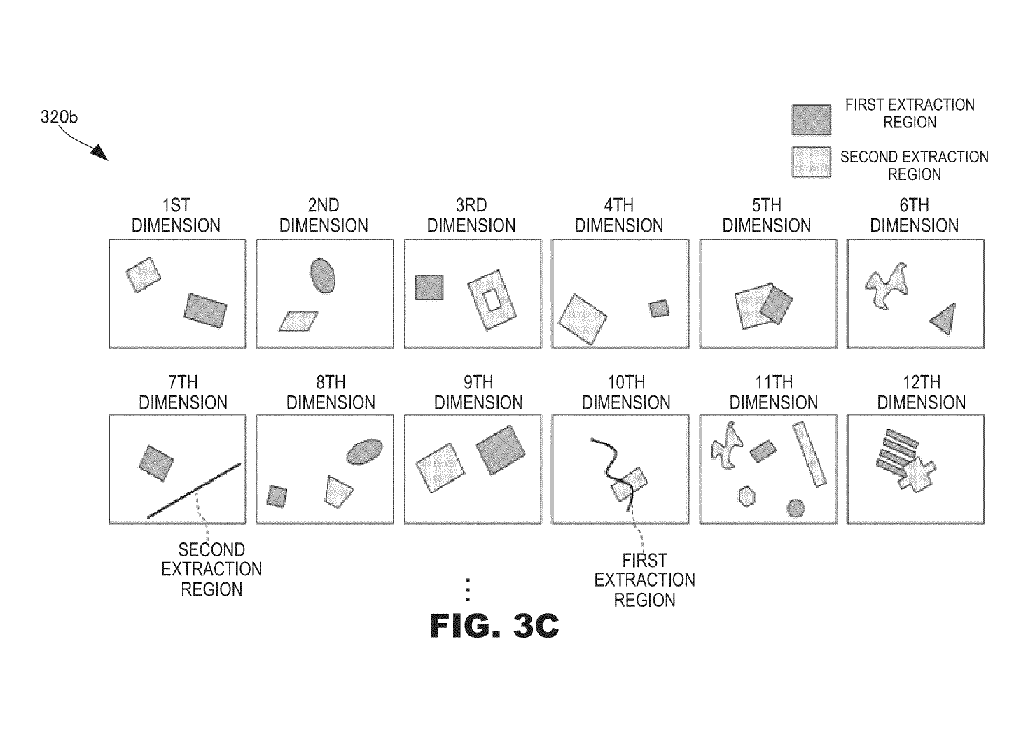

FIG. 3A is a block diagram showing the arrangement of the frame feature extractor 221 according to this embodiment. The frame feature extractor 221 applied in this embodiment is a functional component that extracts a video signature employed in standardization of MPEG7.

Referring to FIG. 3A, an output frame feature 350 is generated by providing a number of pairs of regions having different sizes or shapes in each frame of a captured video, quantizing (actually, ternarizing) a difference in average luminance value as a kind of region feature between a pair of regions and encoding the quantized values of the differences. A dimension determination unit 310 determines the number of region pairs. One dimension corresponds to one region pair. An extraction region acquisition unit 320 acquires the region pair of each dimension to calculate a frame feature in accordance with the determination of the dimension determination unit 310. A region feature calculator 330 includes a first region feature calculator 331 and a second region feature calculator 332, each of which calculates the average luminance as a kind of region feature of each region of the region pair of each dimension. A region feature difference encoder 340 calculates the difference of the average luminances as region features of respective regions of the region pair, quantizes and encodes the difference in accordance with a third threshold, and outputs the frame feature 350.

In this example, the region feature represented by the average luminance will be explained below. However, the region feature is not limited to the average luminance of the region. Another processing of the luminance or a frame feature other than the luminance is also applicable.

FIG. 3B is a view showing processing of the frame feature extractor according to this embodiment.

In FIG. 3B, 320a indicates several examples of region pairs acquired by the extraction region acquisition unit 320 shown in FIG. 3A. In 320a, each outer frame represents a frame, and each internal rectangle represents a region.

In FIG. 3B, 330a expresses the relationship of extracting regions of region pairs from the extraction region acquisition unit 320 and calculating the difference between the regions in a frame image. A state in which two regions of a region pair are extracted in the frame image, the average luminance of the pixels included in each region is calculated, and the difference of the average luminances is calculated is indicated by an arrow that connects the centers of the regions.

In FIG. 3B, 340a represents a state in which the calculated difference is quantized. In 340a, if the difference obtained by subtracting a second region feature from a first region feature in FIG. 3A is equal to or smaller than the difference serving as the third threshold indicated by the broken lines on both sides of the difference “0” (corresponding to a case in which the average luminances equal), “0” is the output value of quantization. If the difference is a positive (+) value on the positive side of the broken line, “+1” is the output value of quantization. If the difference is a negative (−) value on the negative side of the broken line, “−1” is the output value of quantization. The difference is thus encoded to the three values “−”, “0” and “+1” to decrease the data amount of each dimension and generate information of dimensions as many as possible, thereby facilitating separation of the frame features and decrease the calculation amount in comparison of the frame features. It is therefore unnecessary to limit to the example of the three values. Note that the third threshold indicated by the broken line is selected based on the ratio of “0” and quantized difference values in the distribution of difference values of all dimensions to be used. For example, a value with which the ratio of “0” and quantized difference values becomes 50% is selected.

In FIG. 3B, 350a represents an example of a frame feature generated by collecting the results of quantization of the differences. As a simple example, the frame feature is generated by arranging the quantized values of the differences in the one-dimensional direction in the order of dimension. Note that the frame feature is not limited to this example and need not always be obtained by simply arranging the quantized values of the differences in the one-dimensional direction in the order of dimension but may be generated by arranging the values in multidimensional directions or further applying an additional operation.

FIG. 3C is a view showing the extraction regions of the frame feature extractor according to this embodiment.

In FIG. 3B, 320a indicates the region pair of each dimension by two rectangular regions. However, to calculate a frame feature appropriately expressing a frame, a shape other than a rectangle may be preferable. Extraction regions shown in FIG. 3C exemplify region pairs each including two regions that are not rectangular. Several hundred dimensions can be set even when comparison of frame features in real time or comparison of video content frame feature groups that are sets of frame features by ternarizing each dimension, as indicated by 340a in FIG. 3B.

(Arrangement of Frame Feature DB)

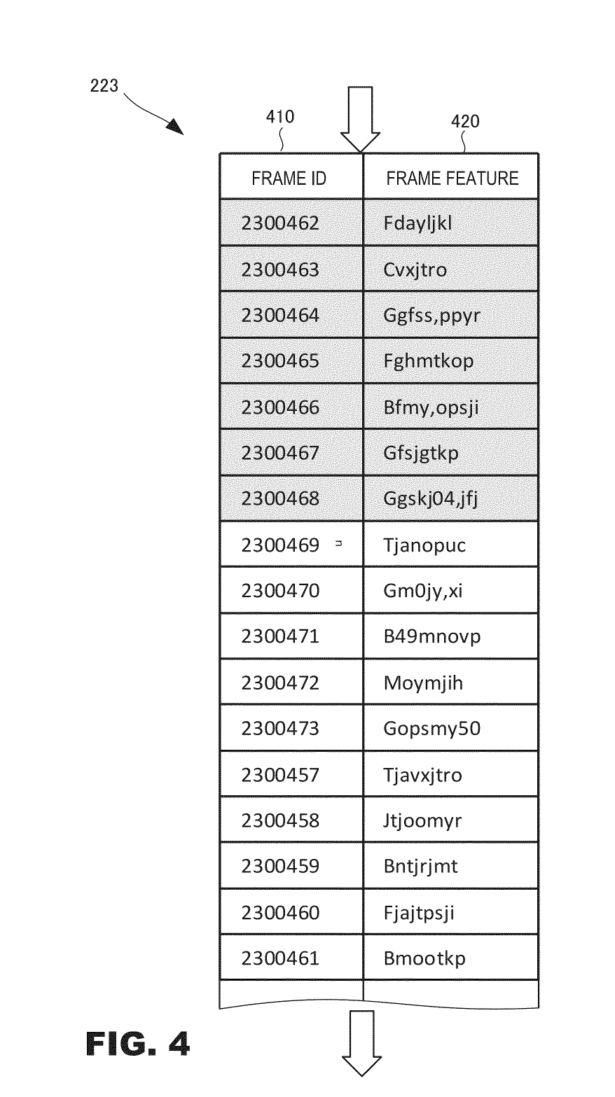

FIG. 4 is a view showing the arrangement of the frame feature DB according to this embodiment.

The frame feature DB 223 shown in FIG. 4 sequentially accumulates a frame feature 420 extracted by the frame feature extractor 221 in association with a frame ID 410 that specifies each frame in a video content. Note that the number of frames accumulated in the frame feature DB 223 corresponds to the range where the search of the frame searcher 224 is necessary. This range is not unlimited and is set up to the point at which the video apparatus captures almost the same capturing range at the same position. Hence, in this embodiment in which the frame features are compared, the frame images of the video need not be stored. Additionally, since the storage length is limited, the capacity of the storage medium can be decreased.

(Arrangement and Processing of Frame Searcher)

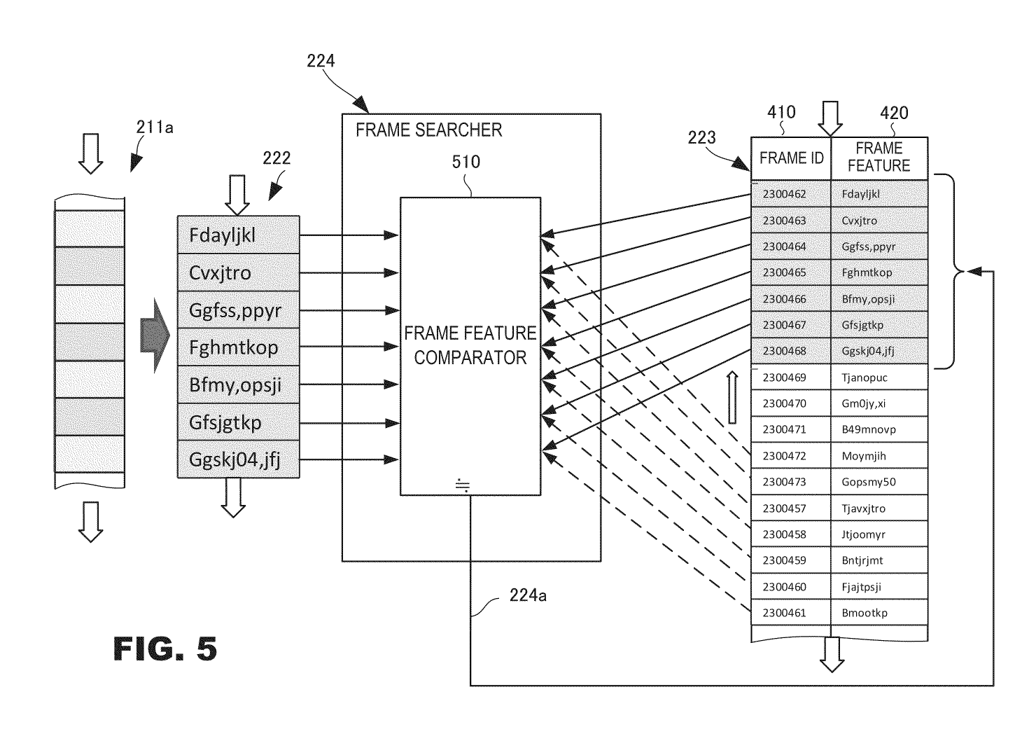

FIG. 5 is a view showing the arrangement and processing of the frame searcher 224 according to this embodiment.

The frame searcher 224 compares the frame feature sequence in the feature buffer 222 that stores a plurality of continuous frame features with a frame feature sequence accumulated in the frame feature DB 223 and searches for a similar frame feature sequence.

Referring to FIG. 5, the new frame feature 221a is sequentially input to the feature buffer 222 and shifted. The frame searcher 224 includes a frame feature comparator 510. The frame feature comparator 510 compares the new frame feature sequence from the feature buffer 222 with the preceding frame feature sequence read out from the frame feature DB 223 and outputs the signal 224a when the difference is equal to or smaller than the first threshold. The signal 224a specifies the currently readout frame feature sequence in the frame feature DB 223.

Note that the frame feature sequence comparison in the frame searcher 224 is done to, for example, search for the similarity of background image in the capturing range. Hence, one or more dimensions appropriate for searching for the similarity of background image may be selected from multiple dimensions of the frame feature. Alternatively, when the frame features are compared, a small weight may be added to a dimension that is associated with the background image just a little, or the difference of a dimension that is associated with the background image just a little may be neglected based on the first threshold. In this way, the similarity of background image in the capturing range can be determined by comparing the frame feature sequences.

(Arrangement and Processing of Change Detector)

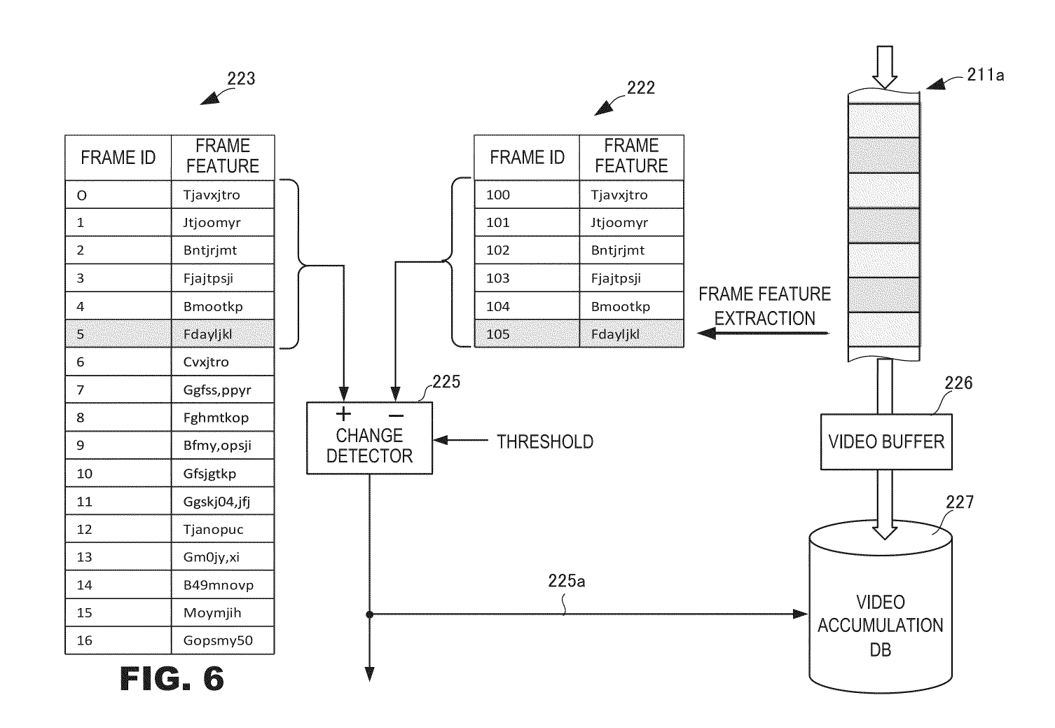

FIG. 6 is a view showing the arrangement and processing of the change detector 225 according to this embodiment.

The change detector 225 calculates the difference between the new frame feature sequence and the frame feature sequence in the frame feature DB 223 found by the frame searcher 224 and detects a change. The change detector 225 accumulates a video of a predetermined length formed from a plurality of frames including the frame where the change is detected.

Referring to FIG. 6, the change detector 225 recognizes the presence of a change when the frame feature sequence from the feature buffer 222 and the frame feature sequence from the frame feature DB 223 having the similar background found by the frame searcher 224 have a difference more than the threshold (second threshold). The change detector 225 outputs the signal 225a representing the presence of the change. The video accumulation DB 227 accumulates a video of a predetermined length including the frame where the change is detected, which is received from the video frame 211a via the video buffer 226.

Note that the change detector 225 can calculate the difference either for all frame features or only for dimensions different from the one or more dimensions used by the frame searcher 224 to search for the similarity of background. Alternatively, dimensions with equal values in the comparison of the frame searcher 224 may be excluded from the difference calculation of the change detector 225. Those above processings allow to further decrease the calculation load. The predetermined length can be either a predetermined time length, or a video up to the frame found by the frame searcher 224 or a video up to a similar frame before the frame found by the frame searcher 224. The length of the accumulated video has an influence on a tradeoff relationship between the recognition rate of the monitoring target and the storage capacity, and then an appropriate length is selected.

(Arrangement of Video Accumulation DB)

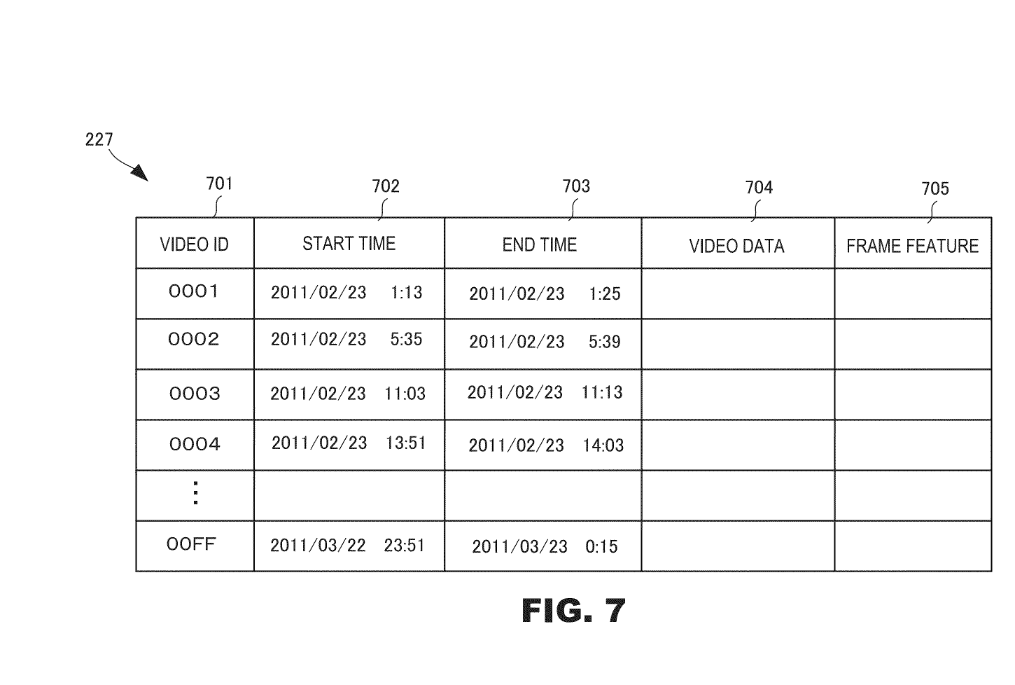

FIG. 7 is a view showing the arrangement of the video accumulation DB 227 according to this embodiment.

The video accumulation DB 227 accumulates a video of a predetermined length including a frame with a change when the change detector 225 has detected a change of the capturing target.

The video accumulation DB 227 shown in FIG. 7 accumulates a start time 702 including the capture start date/time, an end time 703 including an end date/time, video data 704 between the times, and a frame feature 705 between the times in association with a video ID 701 that uniquely specifies an accumulated video. Note that the frame feature 705 is an option and is not indispensable accumulated data.

<Hardware Arrangement of Video Processing Apparatus>

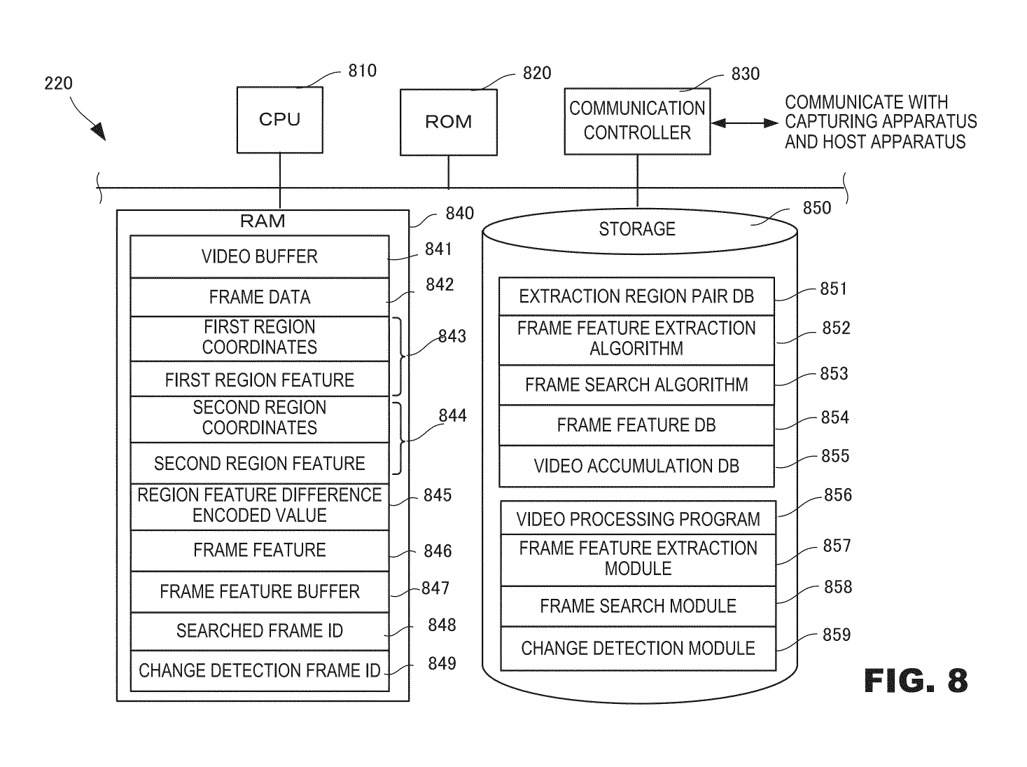

FIG. 8 is a block diagram showing the hardware arrangement of the video processing apparatus 220 according to this embodiment.

Referring to FIG. 8, a CPU 810 is a processor for arithmetic control and implements each functional component shown in FIG. 2 by executing a program. A ROM 820 stores initial data, permanent data of programs and the like, and the programs. A communication controller 830 communicates with the capturing apparatus 210 or a host apparatus. Note that the communication controller 830 may be formed from a plurality of communication controllers that separately have the above-described two connections. Communication can be either wireless or wired. In this example, communication with the capturing apparatus 210 is assumed to be performed through a dedicated line without using a network and, more particularly, a public network.

A RAM 840 is a random access memory used by the CPU 810 as a work area for temporary storage. An area to store data necessary for implementing the embodiment is allocated in the RAM 840. Reference numeral 841 denotes a video buffer corresponding to the video buffer 226 shown in FIG. 2, which stores an input video; 842, frame data of each frame; 843, first region coordinates to set a first region on a frame and a first feature as its feature; 844, second region coordinates to set a second region on a frame and a second feature as its feature; 845, a region feature difference encoded value that is a ternary value in the example of each dimension and is output by quantizing the difference between the first region feature and the second region feature; 846, a frame feature generated by combining the region feature difference encoded values 845 as many as the number of dimensions; 847, a frame feature buffer corresponding to the feature buffer 222 that temporarily stores a predetermined number of continuous frame features 846; 848, a frame ID of a frame searched as a similar frame; and 849, a change detection frame ID representing a frame having a change of the capturing target detected from the difference between the similar frames.

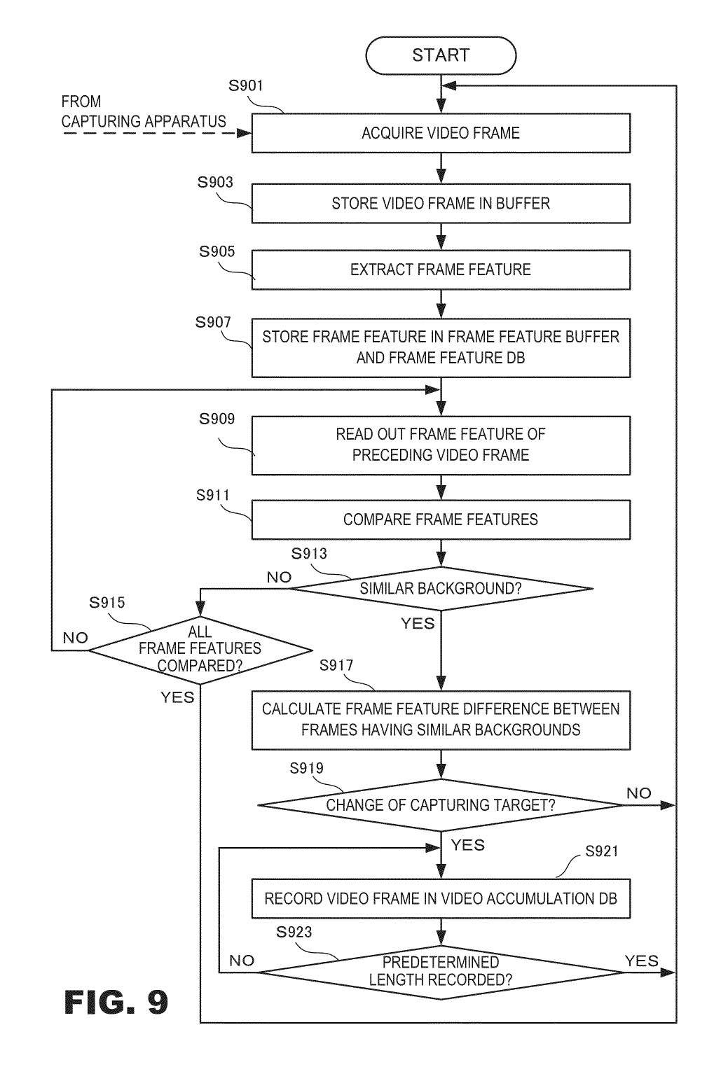

A storage 850 stores databases, various kinds of parameters, and following data and programs necessary for implementing the embodiment. Reference numeral 851 denotes an extraction region pair DB that stores all extraction region pairs used in this embodiment; 852, a frame feature extraction algorithm shown in FIGS. 3A to 3C; 853, a frame search algorithm shown in FIG. 5; 854, a frame feature DB corresponding to the frame feature DB 223 shown in FIGS. 2; and 855, a video accumulation DB corresponding to the video accumulation DB 227 shown in FIG. 2. The storage 850 stores the following programs. A video processing program 856 executes overall processing (see FIG. 9). A frame feature extraction module 857 indicates the procedure of frame feature extraction in the video processing program 856. A frame search module 858 indicates the procedure of searching for a similar frame in the video processing program 856. A change detection module 859 indicates the procedure of detecting a change of the capturing target in a frame in the video processing program 856.

Note that FIG. 8 illustrates only the data and programs indispensable in this embodiment but not general-purpose data and programs such as the OS.

<Processing Procedure of Video Processing Apparatus>

FIG. 9 is a flowchart showing the processing procedure of the video processing apparatus 220 according to this embodiment. The CPU 810 shown in FIG. 8 executes this flowchart using the RAM 840, thereby implementing the functional components shown in FIG. 2.

In step S901, the video frame 211a is acquired from the capturing apparatus 210. In step S903, the acquired video frame is stored in the video buffer 226. On the other hand, in step S905, a frame feature is extracted from the acquired video frame. Next, the frame feature is stored in the frame feature buffer and the frame feature DB. In step S909, the frame feature previously accumulated in the frame feature DB is read out. In step S911, the values of a dimension to judge the similarity of background are compared between the frame feature in the frame feature buffer and the frame feature read out from the frame feature DB. In step S913, it is judged based on the comparison result whether the two frames have similar backgrounds.

If the backgrounds are not similar, the process returns to step S909 to read out the next frame feature from the frame feature DB and repeat comparison. Upon judging that the backgrounds are similar, the process advances to step S917 to calculate the frame feature difference between the frames having similar backgrounds. In step S919, it is discriminated based on the magnitude of the difference whether a change of the capturing target exists. If there is no change in the capturing target, the process returns to step S901 without accumulating the video in the video accumulation DB, and the next video frame is acquired from the capturing apparatus 210. If a change of the capturing target exists, the process advances to step S921 to record the video frame including the frame with the change of the capturing target in the video accumulation DB. The processing is repeated until the recorded video frame reaches a predetermined length in step S923. When recording of the predetermined length has ended, the process returns to step S901 to acquire the next video frame from the capturing apparatus 210, and the processing is repeated.

### Third Embodiment

In the second embodiment, an example has been described in which the moving controller changes the capturing range of the video camera. In the third embodiment, a case will be explained in which the capturing range of a video camera is changed by zooming of a zoom controller. According to this embodiment, it is possible to detect a change of a capturing target even if the capturing range by zooming of the capturing apparatus changes every moment and also decrease the amount of the recorded video because recording only a portion where the change is detected suffices. Note that this embodiment is different from the second embodiment only in that the change of the capturing range by the moving controller is replaced with the change of the capturing range by the zoom controller, and the rest of the arrangement and processing of the video processing system is the same as in the second embodiment. Hence, only the different point will be described, and a description of other points will be omitted.

<Arrangement of Video Processing System>

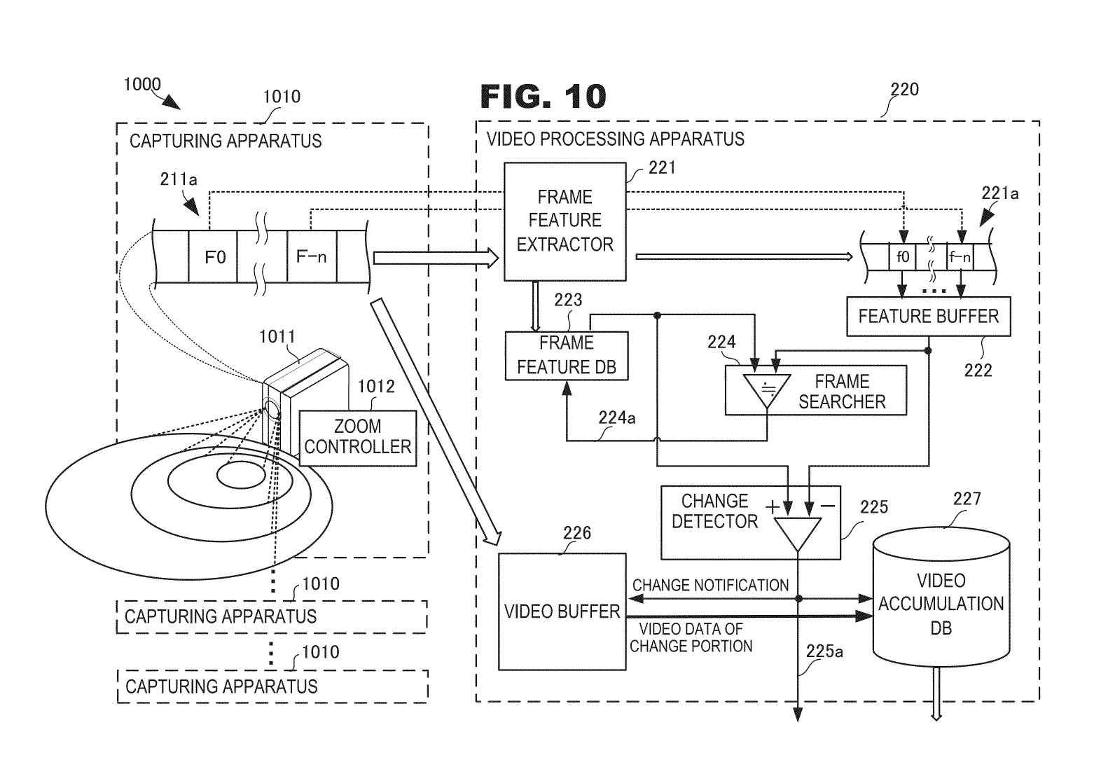

FIG. 10 is a block diagram showing the arrangement of a video processing system 1000 according to this embodiment. Referring to FIG. 10, functional components denoted by the same reference numerals as in FIG. 2 of the second embodiment have the same functions as in the second embodiment.

A capturing apparatus 1010 shown in FIG. 10 includes a zoom controller 1012, and a video camera 1011 that acquires a close video in a narrow range upon zoom-in under the control of the zoom controller 1012 and an overall video in a wide range upon zoom-out. Note that processing of each frame image in a video processing apparatus 220, including frame feature extraction, is the same as in the second embodiment except that the capturing range is changed by changing the position in the second embodiment but by changing the area in this embodiment.

### Fourth Embodiment

In the second and third embodiments, the capturing apparatus and the video processing apparatus for managing the capturing apparatus are assumed to be connected via a leased line or a dedicated line. However, an arrangement in which a plurality of capturing apparatuses are connected to the video processing apparatus via a network is also available. In this embodiment, a plurality of capturing apparatuses are connected to the video processing apparatus via a network. To reduce traffic on the network, each capturing apparatus includes a frame feature extractor and a video buffer. According to this arrangement, not the image data of a video but a frame feature is communicated via the network. In addition, only a video that needs to be accumulated because of a change of the capturing target is communicated. According to this embodiment, when a plurality of capturing apparatuses are connected to the video processing apparatus via a network, traffic on the network can be reduced. Note that this embodiment is different from the second embodiment only in that the frame feature extractor and the video buffer are moved to the capturing apparatus, and the arrangement and processing of the overall video processing system are the same as in the second embodiment. Hence, only the different point will be described.

<Arrangement of Video Processing System>

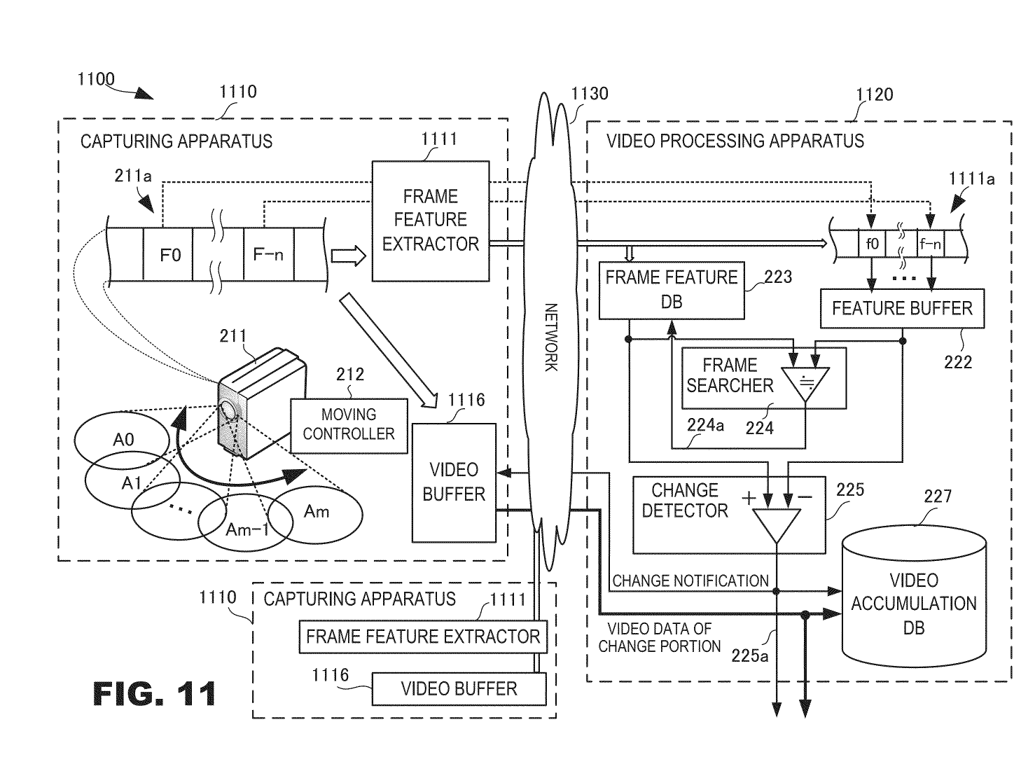

FIG. 11 is a block diagram showing the arrangement of a video processing system 1100 according to this embodiment. Referring to FIG. 11, functional components denoted by the same reference numerals as in FIG. 2 of the second embodiment have the same functions as in the second embodiment.

Referring to FIG. 11, a plurality of capturing apparatuses 1110 are connected to a video processing apparatus 1120 via a network. A frame feature extractor 1111 and a video buffer 1116 shown in FIG. 11 are the same as in the second embodiment and are arranged in the capturing apparatus 1110. A frame feature 1111a extracted by the frame feature extractor 1111 is transmitted from the capturing apparatus 1110 to the video processing apparatus 1120 via the network. In addition, the video is temporarily saved in the video buffer 1116 of the capturing apparatus 1110. A change detector 225 in the video processing apparatus 1120 that is the transmission destination of the frame feature 1111a detects a change of the capturing target between similar frames and returns a signal 225a for notifying the change to the capturing apparatus 1110 as information representing the change of the capturing target. Only upon receiving the signal 225a for notifying the change, the capturing apparatus 1110 transmits a video of a predetermined length from the video buffer 1116 to the video processing apparatus 1120 via the network. A video accumulation DB 227 in the video processing apparatus 1120 accumulates only the video transmitted from the capturing apparatus 1110.

### Fifth Embodiment

In the second to fourth embodiments, the video processing apparatus is provided independently of the capturing apparatus to process or accumulate a video. In the fifth embodiment, however, a case will be described in which the capturing apparatus itself not only extracts a frame feature but also detects a change of a capturing target in a frame, selects a video in which the capturing target changes, and accumulates it in a video accumulation DB. The video accumulated in the video accumulation DB of the capturing apparatus is read out as needed. Note that when a change of the capturing target is detected, a notification representing it and the video may be output. According to this embodiment, since the capturing apparatus performs all processes, no video processing apparatus needs to be provided separately, and an inexpensive system can be implemented. For example, if the video processing apparatus of the second embodiment is integrated on one-chip IC, the system can be implemented only by including the chip in the capturing apparatus. Note that this embodiment is different from the second or fourth embodiment only in that the functional components are arranged in the capturing apparatus, and their functional arrangements and operations are the same as in the second or fourth embodiment. Hence, only the different point will be described below.

<Arrangement of Video Processing System>

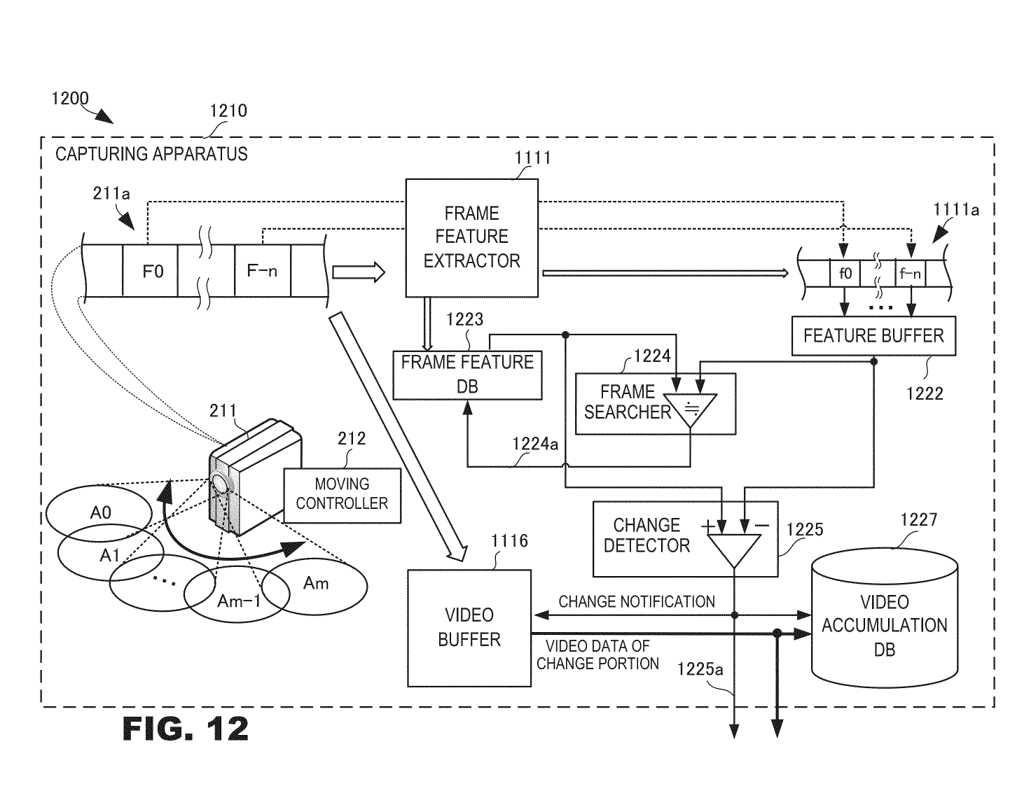

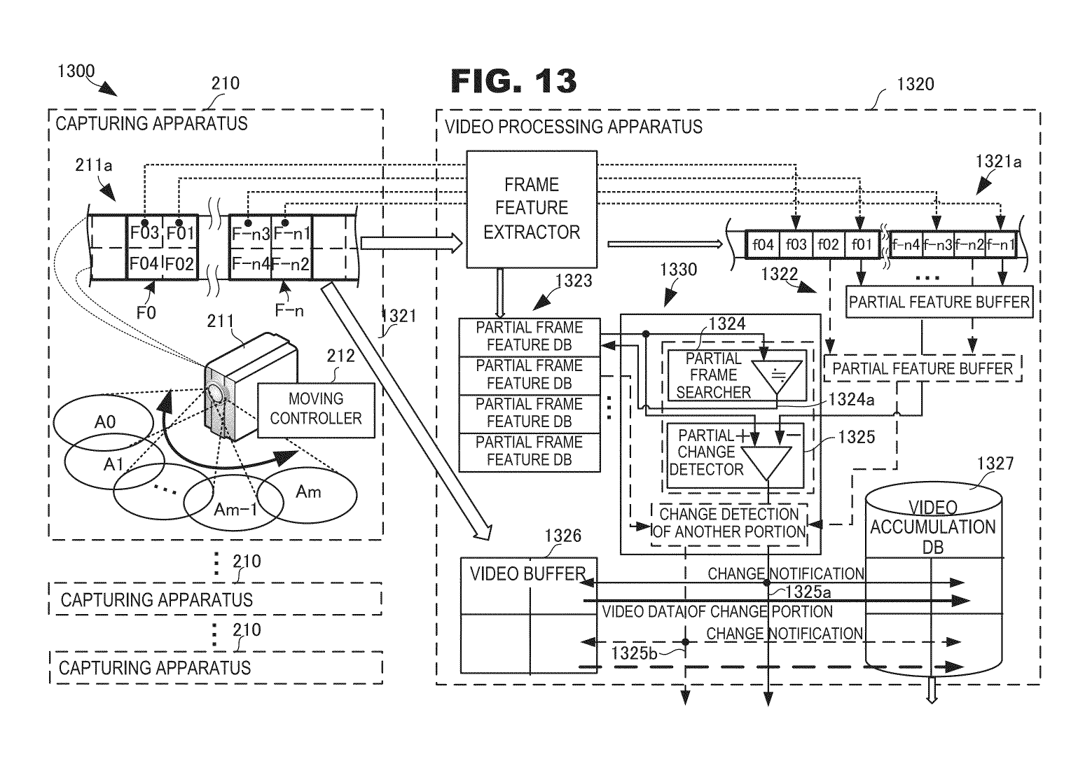

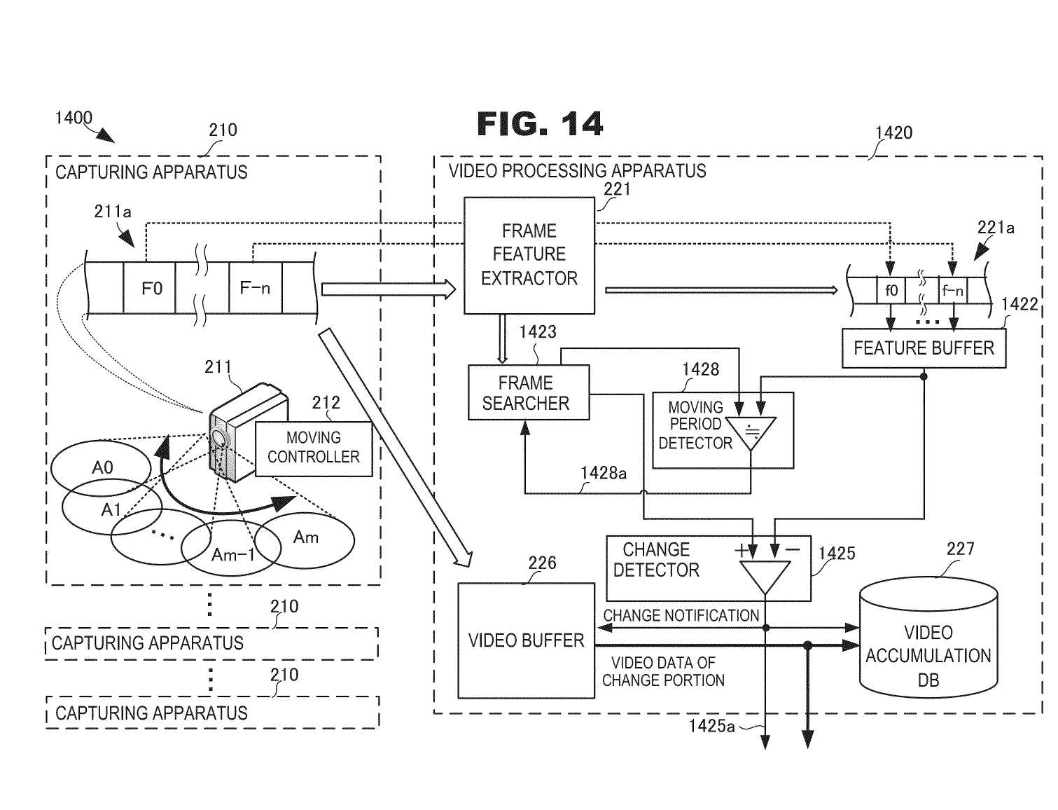

FIG. 12 is a block diagram showing the arrangement of a video processing system 1200 according to this embodiment. Referring to FIG. 12, functional components denoted by the same reference numerals as in FIG. 2 of the second embodiment and FIG. 11 of the fourth embodiment have the same functions as in the second and fourth embodiments.

In FIG. 12, a feature buffer 1222, a frame feature DB 1223, a frame searcher 1224, a change detector 1225, and a video accumulation DB 1227, which are arranged in the video processing apparatus in FIG. 11, are included in a capturing apparatus 1210. The arrangements and operations of the functional components are the same as in FIGS. 2 and 11.

### Sixth Embodiment

In the second to fifth embodiments, judging whether a frame is similar or determining whether a change of the capturing target exists is done for each frame of a video. In the sixth embodiment, each frame image is segmented into a plurality of areas, a partial frame feature in each area is extracted, and similarity judgment and determination are performed for each area. A video is accumulated in a video accumulation DB for each area where a change of the capturing target exists. According to this embodiment, since the video can be accumulated in the video accumulation DB for each area, the storage capacity can be made smaller than in the second to fifth embodiments. In the arrangement and processing of this embodiment, the functional components shown in FIG. 2 are modified to process not each frame but each segmented area of a frame. However, their internal arrangements and operations are the same as in the case in which the processing is performed for each frame. Hence, only the arrangement is illustrated, and a detailed description of the operation will be omitted. In this embodiment, an example in which one frame is equally segmented into four areas will be described. However, the number of segmentations and the segmentation method are not limited. In addition, this embodiment can also be implemented by setting a plurality of areas in one frame instead of segmenting a frame.

<Arrangement of Video Processing System>

FIG. 13 is a block diagram showing the arrangement of a video processing system 1300 according to this embodiment. Referring to FIG. 13, functional components denoted by the same reference numerals as in FIG. 2 of the second embodiment have the same functions as in the second embodiment.

A capturing apparatus 210 includes a moving controller 212, and a video camera 211 that changes the capturing range while being moved by the moving controller 212. FIG. 2 illustrates panning as the movement. The video camera 211 sequentially captures capturing ranges A0 to Am, and outputs frame images F−n to F0 to the video processing apparatus 220 as video frames 211a. Each of the frame images F-n to F0 of the video frame 211a is segmented into four areas, and the areas are defined as F−n1 to F−n4, . . . , F01 to F04 in correspondence with the respective frame images.

In the video processing apparatus 1320, a frame feature extractor 1321 extracts a partial frame feature 1321a of each area from the input video frame 211a. The frame feature extractor 1321 accumulates the partial frame features in a partial frame feature DB 1323 and also temporarily stores them in a partial feature buffer 1322. The partial frame features 1321a are output in the order of f−n1 to f−n4, . . . , f01 to f04 in correspondence with the respective areas. Each of the partial frame feature DB 1323 and the partial feature buffer 1322 includes a plurality of structures provided in correspondence with the respective areas. Note that the partial feature buffer 1322 has a capacity to store the partial frame feature of at least one area. Actually, the partial feature buffer 1322 preferably has a capacity to store the partial frame features of a plurality of identical areas of continuous frames to raise the partial frame search accuracy of a partial frame searcher 1324. The partial frame searcher 1324 compares a preceding partial frame feature accumulated in one of the partial frame feature DBs 1323 with a newly obtained partial frame feature or partial frame feature sequence stored in one of the partial feature buffers 1322. The partial frame searcher 1324 searches for a frame having a difference smaller than a first threshold as a frame having a similar background. Upon finding an area having a similar background, the partial frame searcher 1324 outputs a signal 1324a to the partial frame feature DB 1323 of the output source. A partial change detector 1325 calculates the difference between the partial frame feature of the capturing target in the area having a similar background from the partial frame feature DB 1323 of the output source and the partial frame feature of the capturing target in the newly input area, and detects a change if the difference is larger than a second threshold. The partial change detector 1325 notifies, for example, an external observer of the detected change by a change detection signal 1325a, and also accumulates, in a video accumulation DB 1327, a video of a predetermined length including the image of the area corresponding to the area where the change is detected from the video temporarily stored in a video buffer 1326. Notification to the observer may include video transmission. Processing of other areas is the same as described above, and a detailed description thereof will be omitted. A case in which a change of the capturing target in the next area is detected is indicated together with a signal 1325b.

### Seventh Embodiment

In the second to sixth embodiments, the change of the capturing range by the movement of the video camera or zooming is not limited. However, when the video camera is used as an actual monitoring camera, it often pans or zooms regularly and periodically. In this embodiment, detection of a change of a capturing target by a video camera that periodically pans is performed by detecting the period and selecting frames to be compared. According to this embodiment, accumulating frame features of one period or ½ period for reciprocal processing in the frame feature DB suffices to detect the change and the period. It is therefore possible to further reduce the frame feature storage capacity. Note that the seventh embodiment is different from the second embodiment in the frame feature DB having a smaller storage capacity and the feature buffer that stores continuous frame feature sequences until detection of the moving period. In addition, a moving period detector obtains the moving period in place of the frame searcher. A change detector detects a change of the capturing target from the frame feature difference between frames selected based on the moving period. Hence, the different points will be described below, and a description of the same arrangements and operations as in the second embodiment will be omitted.

<Arrangement of Video Processing System>

FIG. 14 is a block diagram showing the arrangement of a video processing system 1400 according to this embodiment. Referring to FIG. 14, functional components denoted by the same reference numerals as in FIG. 2 of the second embodiment have the same functions as in the second embodiment.

A moving period detector 1428 shown in FIG. 14 compares a predetermined number of continuous frame feature sequences stored in a feature buffer 1422 with an immediately preceding frame feature sequence corresponding to ½ or one period accumulated in a frame feature DB 1423 and detects the moving period. A change detector 1425 calculates the difference between a new frame feature stored in a feature buffer 222 and a frame feature at a time (=storage position) corresponding to the moving period, which is accumulated in the frame feature DB 1423, based on the moving period detected by the moving period detector 1428, and detects a change of the capturing target. Upon detecting a change of the capturing target, the change detector 1425 notifies an observer or the like of the change of the capturing target. At the same time, the change detector 1425 accumulates, in a video accumulation DB 227, a video of a predetermined length including the frame with the change of the capturing target from the video temporarily stored in a video buffer 226. Note that the video after the change of the capturing target may be transmitted to the observer.

<Arrangement and Operation of Moving Period Detector>

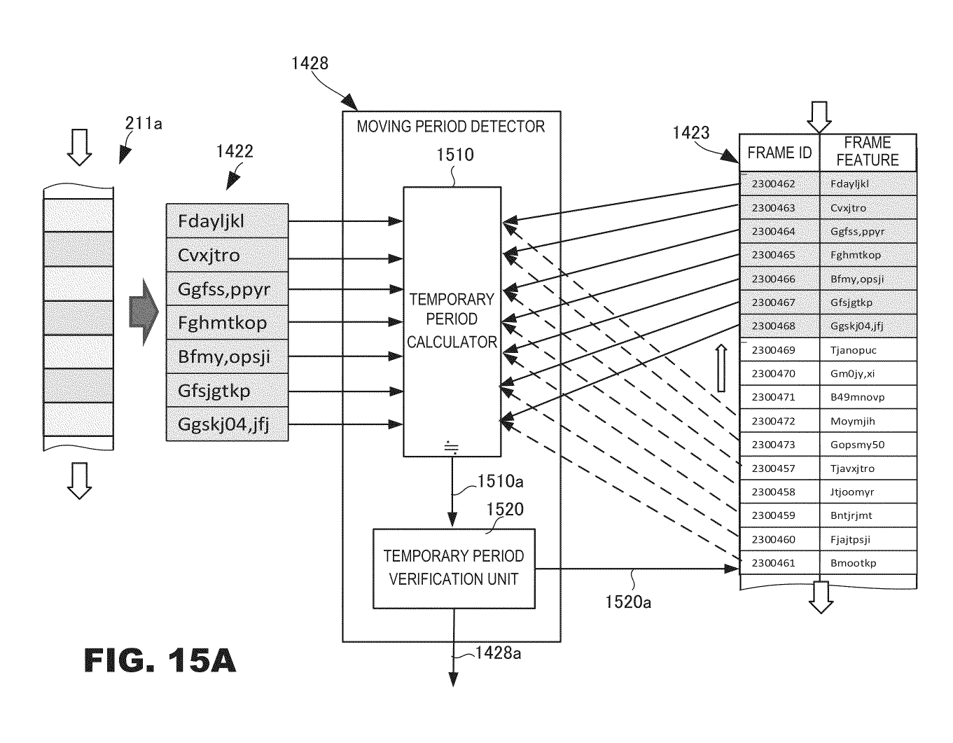

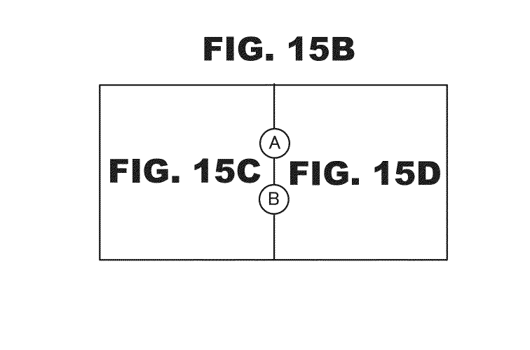

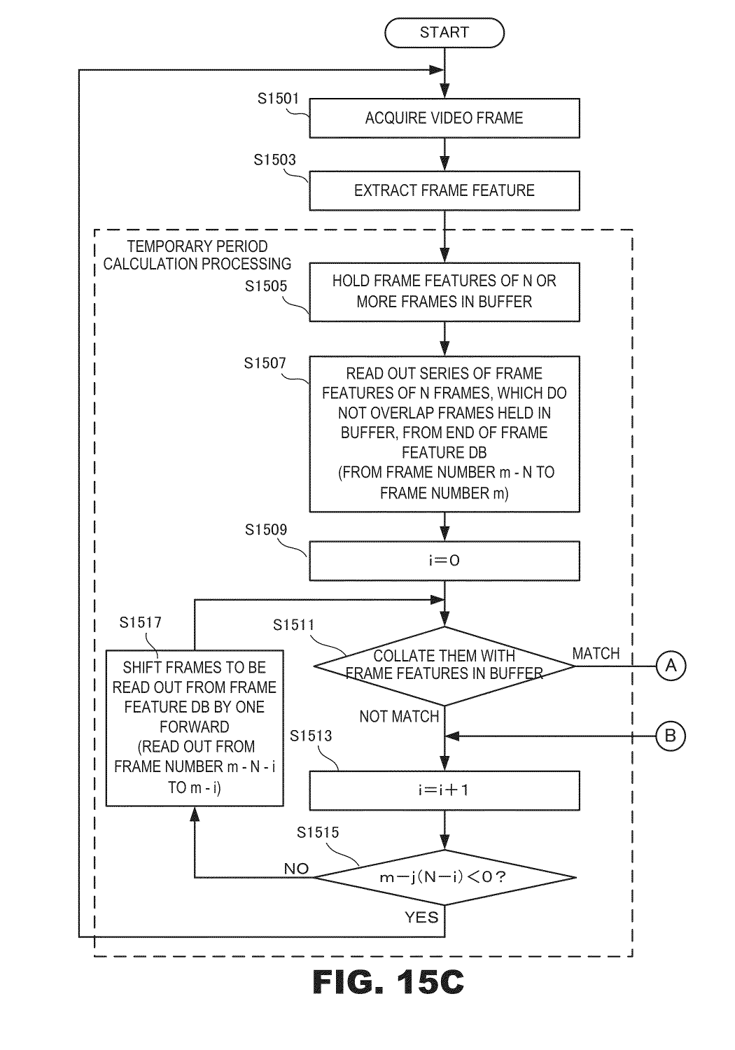

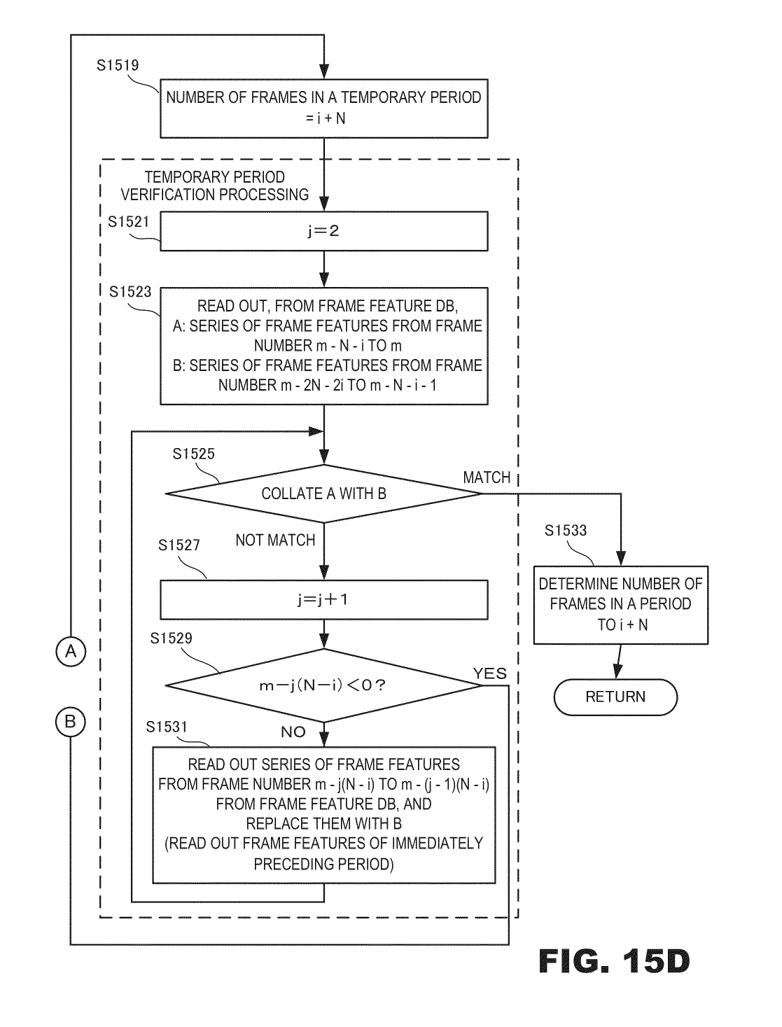

FIG. 15A is a view showing the arrangement and operation of the moving period detector 1428 according to this embodiment.

Referring to FIG. 15A, a plurality of continuous frame features 221a are set in the feature buffer 1422. The moving period detector 1428 includes a temporary period calculator 1510. The temporary period calculator 1510 searches for a similar frame feature sequence based on a fourth threshold by comparing the frame feature sequence from the feature buffer 1422 with the preceding frame feature sequence corresponding to ½ or one period which is read out from the frame feature DB 1423. Upon finding a similar frame feature sequence, the temporary period calculator 1510 calculates a temporary period 1510a from the number of frames during the time and outputs it.

A temporary period verification unit 1520 verifies whether the temporary period 1510a can be decided as the moving period. That is, the similar frame feature sequence may be obtained because the temporary period 1510a happens to meet the condition of the fourth threshold. Hence, the frame features of one period are compared based on the temporary period 1510a. If the frame features match, the temporary period 1510a is formally decided as the moving period. If the frame features do not match, the frame features of one period to be compared are replaced, and the verification is performed again. If the frame features do not match yet, the temporary period 1510a is judged as wrong. The addresses of the frame feature sequence read out from the frame feature DB 1423 are shifted by a signal 1520a, and the temporary period detection is started again.

(Control Procedure of Moving Period Detector)

FIG. 15B is a flowchart showing the control procedure of the moving period detector 1428 according to this embodiment. Although not illustrated in FIG. 8, a CPU 810 that is the same as in FIG. 8 and is included in the video processing apparatus executes this flowchart using a RAM 840, thereby implementing the functional components shown in FIG. 14.

In steps S1501 to S1509, initial preparation is performed. In step S1501, a video frame is acquired from a capturing apparatus 210. In step S1503, the frame feature of each frame image is extracted. In step S1505, a frame feature sequence of N frames or more is held in the feature buffer. N is the minimum number of frame feature sequences necessary for accurately detecting the moving period. If N is too small, a wrong period is detected at a high possibility. On the other hand, if N is too large, no period may be detected. Hence, an appropriate number is selected. In step S1507, a series of frame features of N frames, which do not overlap the N or more frame feature sequences held in the feature buffer, are read out from the end of the frame feature DB. In step S1509, variable i=0 is set.

In steps S1511 to S1517, a frame feature sequence in the feature buffer and a frame feature sequence in the frame feature DB are compared. In step S1511, a frame feature sequence in the feature buffer is compared with a frame feature sequence in the frame feature DB, and it is determined whether they match. If the frame feature sequences match, the process advances to step S1519 to set the number of frames of the temporary period to (i+N) and verify the temporary period. If the frame feature sequences do not match, the process advances to step S1513 to increment the variable i by “1”. In step S1515, it is judged whether the comparison has ended for all frame feature sequences without matching. If a frame feature sequence to be compared remains, the process advances to step S1517 to shift the frame feature sequence to be read out from the frame feature DB by one forward. If the comparison has ended without matching, the process returns to step S1501 to acquire a new video frame and repeat the processing.

Note that steps S1505 to S1515 can be summarized as temporary period calculation processing.

If the frame feature sequences match in step S1511, the number of frames in a temporary period is set to (i+N) in step S1519. In step S1521 to S1531, it is verified whether the number of frames (i+N) in the temporary period is correct. In step S1521, a variable j is initialized to 2. In step S1523, two series of frame features are read out from the frame feature DB at an interval corresponding to the number of frames (i+N) in the temporary period. In step S1525, the two series of frame features are compared. It is determined whether the two series of frame features match. That is, if the number of frames (i+N) in the temporary period corresponds to the correct period, the two series frame features at the interval of the number of frames (i+N) in the temporary period should match. If the two series of frame features match, the process advances to step S1533 to determine the number of frames (i+N) as the number of frames in a moving period, and the processing ends.

On the other hand, if the two series of frame features do not match in step S1525, the process advances to step S1527 to increment the variable i by “1”. In steps S1527 to S1531, it is verified whether the series of frame features to be compared is not wrong. In step S1529, it is judged whether the comparison has ended for all frame feature sequences without matching. If the comparison has not ended for all frame feature sequences, the process advances to step S1531 to read out an immediately preceding series of frame features. The process then returns to step S1525 to compare two series of frame features at an interval corresponding to an integer multiple of the number of frames (i+N) in a temporary period again. If the comparison has ended for all frame feature sequences, the detected number of temporary period frames is judged as wrong, and the process returns to step S1513 to increment the number of frames (i+N) in a temporary period by “1” and repeat the temporary period calculation processing.

<Control Procedure of Video Processing Apparatus>

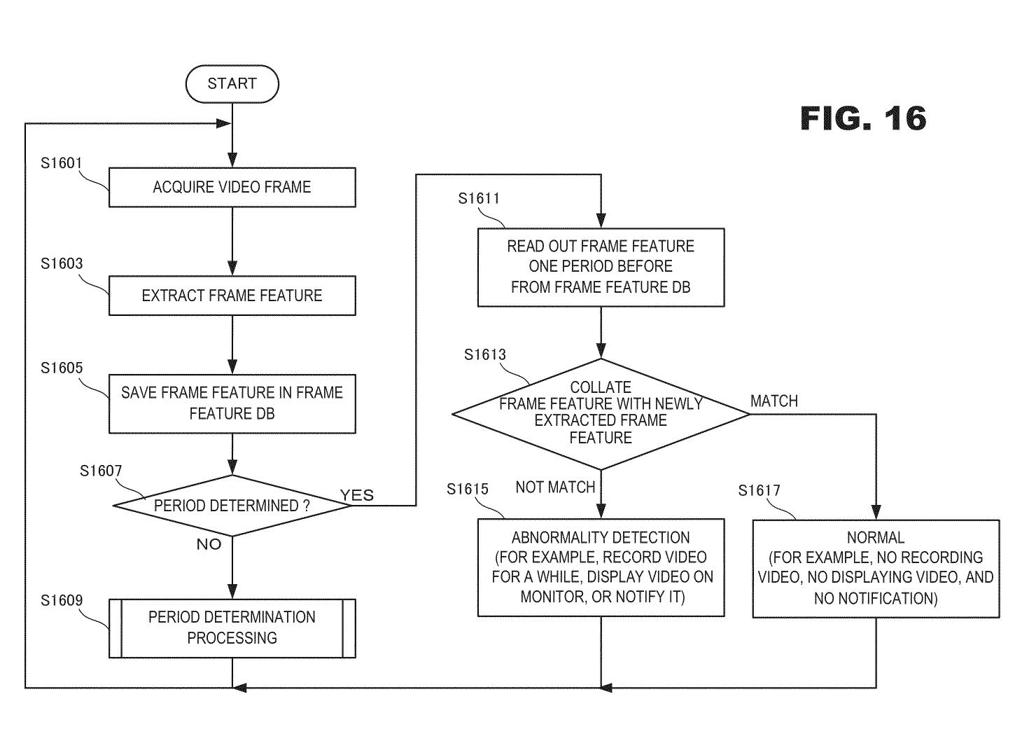

FIG. 16 is a flowchart showing the control procedure of the video processing apparatus according to this embodiment. Although not illustrated in FIG. 8, the CPU 810 that is the same as in FIG. 8 and is included in the video processing apparatus executes this flowchart using the RAM 840, thereby implementing the functional components shown in FIG. 14.

In step S1601, a video frame 211a is acquired from the capturing apparatus 210. In step S1603, a frame feature is extracted from the acquired video frame. In step S1605, the frame feature is stored in the frame feature DB. In step S1607, it is determined whether the period has already been specified. If the period has not been determined yet, the process advances to step S1609 to perform period determination processing. The processing of step S1609 corresponds to the above-described processing of the flowchart in FIG. 15B.

On the other hand, upon judging in step S1607 that the period has already been determined, the process advances to step S1611 to read out, from the frame feature DB, the frame feature of a frame one period before the newly extracted frame feature. In step S1613, the newly extracted frame feature is compared with the frame feature of the frame one period before. If the frame features match (the difference is equal to or smaller than a threshold), it is judged that no special change has occurred in the capturing target. In step S1617, the processing ends without recording or display of the captured video, or notification to the observer. On the other hand, in case of mismatch with a difference larger than the threshold, the process advances to step S1615. It is judged that an abnormality of the capturing target has been detected. The video is recorded for a while or displayed on the monitor of the observer, or the observer is notified of the abnormality by an alarm or the like, and the processing ends.

Note that if the video camera 211 is of a reciprocating type, frames with the same background are obtained there and back. In this case, the frame order is reversed there and back. This allows to shorten the detection time of the moving period of this embodiment and also shorten the detection time of the change of the capturing target.

### Eighth Embodiment

In the seventh embodiment, an arrangement for detecting the period when the video processing apparatus does not know the period of the capturing apparatus has been described. However, if the video processing apparatus knows the period of the capturing apparatus in advance, or the video processing apparatus controls the moving period of the capturing apparatus, the period need not be detected anew. In this embodiment, a moving controller controls the capturing apparatus to a set moving period. It is determined whether the capturing range of the video camera is changed at the set period, and the moving period is corrected. According to this embodiment, when the video processing apparatus knows the period of the capturing apparatus in advance, it is possible to avoid a collation error caused when a frame feature far apart by one period is compared using the moving period. Note that FIG. 2 of the second embodiment and FIG. 14 of the sixth embodiment are different in the moving period storage and the moving period corrector. The arrangements and operations of the remaining functional components are the same as in the second and sixth embodiments, and a description thereof will be omitted.

<Arrangement of Video Processing System>

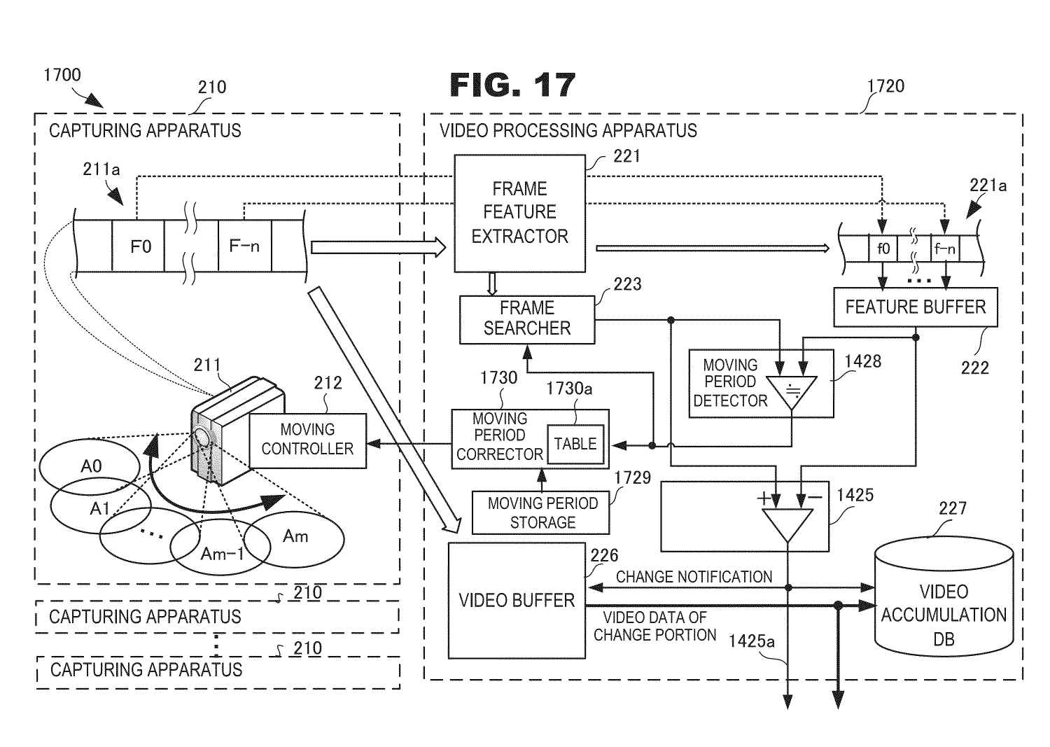

FIG. 17 is a block diagram showing the arrangement of a video processing system 1700 according to this embodiment. Referring to FIG. 17, functional components denoted by the same reference numerals as in FIGS. 2 and 14 have the same arrangements and the same functions as in the second and sixth embodiments.

A moving period storage 1729 of a video processing apparatus 1720 stores a preset moving period. A moving period corrector 1730 includes a table 1730a. A moving period correction value is calculated from a moving period detected from frame features by a moving period detector 1428 and the moving period stored in the moving period storage 1729 and transmitted to a moving controller 212 of a capturing apparatus 210, thereby correcting the moving period of a video camera 211.

The moving controller 212 thus corrects the moving period so as to eliminate the discrepancy between the number of captured frames corresponding to one period and the number of frames corresponding to one period which is detected by the moving period detector 1428. Hence, even when the processors concerning the movement may have a discrepancy, a change detector 1425 can correctly detect a change of the capturing target.

(Arrangement of Table Provided in Moving Period Corrector)

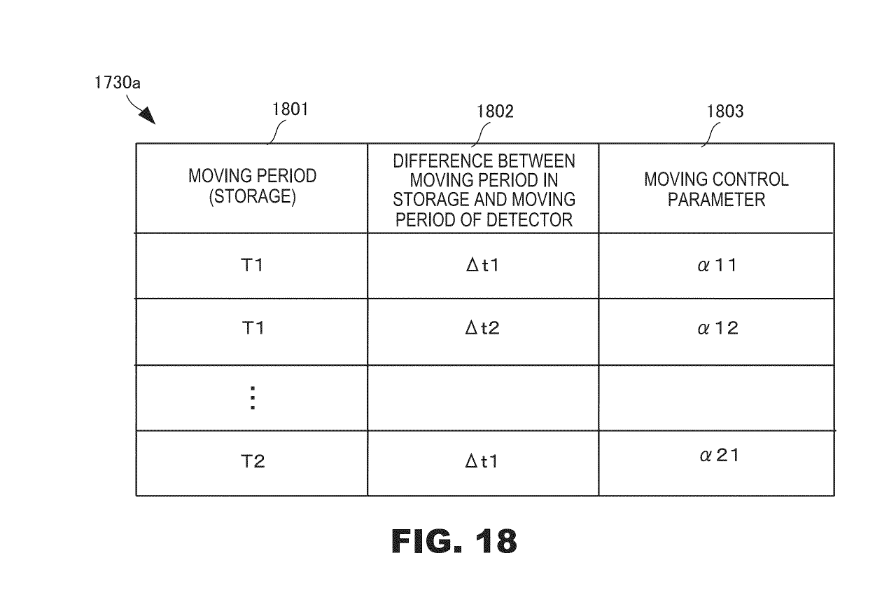

FIG. 18 is a view showing the arrangement of the table 1730a provided in the moving period corrector 1730 according to this embodiment.

FIG. 18 shows the table 1730a that is an example of an arrangement for causing the moving period corrector 1730 to calculate the moving period correction value from the moving period detected from frame features by the moving period detector 1428 and the moving period stored in the moving period storage 1729. The table 1730a stores, in association with a moving period 1801 stored in the moving period storage 1729 and a difference 1802 between the moving period 1801 in the moving period storage 1729 and a moving period detected by the moving period detector 1428, a moving control parameter 1803 to be transmitted to the moving controller 212.

In this embodiment, moving period correction value calculation using the table 1730a has been described. However, the present invention is not limited to this. In this embodiment, the moving period is corrected. However, the moving period corrector 1730 may detect an abnormality such as a fault or breakage of the video camera 211 from the moving period 1801 stored in the moving period storage 1729 and the result of comparison between the moving period 1801 and the moving period detected by the moving period detector 1428.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. The present invention also incorporates a system or apparatus that somehow combines different features included in the respective embodiments.

The present invention is applicable to a system including a plurality of devices or a single apparatus. The present invention is also applicable even when a control program for implementing the functions of the embodiments is supplied to the system or apparatus directly or from a remote site. Hence, the present invention also incorporates the control program installed in a computer to implement the functions of the present invention on the computer, a medium storing the control program, and a WWW (World Wide Web) server that causes a user to download the control program.

This application claims the benefit of Japanese Patent Application No. 2011-067640 filed on Mar. 25, 2011, which is hereby incorporated by reference herein in its entirety.

What is claimed is:

1. A video processing system for detecting a change of a capturing target based on a video whose capturing range changes, comprising:
a capturing unit that captures a video whose capturing range changes;
a feature extractor that extracts a frame feature of each frame from the captured video;
a feature storage that stores the frame feature of the each frame extracted by said feature extractor;
a frame searcher that searches for a frame, a frame feature of which is stored in said feature storage, having a capturing range matching a capturing range of the newly captured frame by comparing a frame feature of a newly captured frame with the frame features stored in said feature storage; and
a change detector that detects a change of the capturing target based on a difference between the frame feature of the newly captured frame and the frame feature of the frame found by said frame searcher.

2. The video processing system according to claim 1, further comprising a period detector that detect a period of frames, the frame features of that are stored in said feature storage, having a matching frame feature as a period at which the capturing range of said capturing unit changes,
wherein said change detector detects a change of the capturing target based on a difference between the frame feature of the newly captured frame and the frame feature stored in said feature storage which is selected in correspondence with the period detected by said period detector at which the capturing range of said capturing unit changes.

3. The video processing system according to claim 2, further comprising:
a period storage that stores a period at which the capturing range of said capturing unit changes; and
a period corrector that corrects, based on a period detected by said period detector at which the capturing range of said capturing unit changes, the period stored in said period storage at which the capturing range of said capturing unit changes.

4. The video processing system according to claim 1, wherein said feature extractor generates the frame feature by combining, as many as a number of region pairs, differences between a pair of region features calculated for each of the region pairs, each region of the region pairs formed on each frame in different sizes or shapes.

5. The video processing system according to claim 4, wherein the region feature is represented by a luminance.

6. The video processing system according to claim 1, wherein the frame feature includes frame features of a plurality of continuous frames.

7. The video processing system according to claim 1, further comprising a video accumulator that accumulates a plurality of frames including the frame where the capturing target has changed, which is detected by said change detector.

8. The video processing system according to claim 7, further comprising a segmentation unit that segments each frame of the captured video into a predetermined number of areas,
wherein said feature extractor extracts a feature for each area, and said change detector detects a change of the capturing target for each area, and
said video accumulator accumulates the areas of the plurality of frames including the frame where the capturing target has changed, which is detected by said change detector.

9. The video processing system according to claim 1, wherein said capturing unit captures the video whose capturing range changes due to panning or zooming.

10. The video processing system according to claim 1, wherein a plurality of capturing units are connected.

11. A video processing method of detecting a change of a capturing target based on a video whose capturing range changes, comprising the steps of:
capturing the video whose capturing range changes;
extracting a frame feature of each frame from the captured video;
storing the frame feature of the each frame extracted in said extracting step into a feature storage;
searching for a frame, a frame feature of which is stored in the feature storage, having a capturing range matching a capturing range of the newly captured frame by comparing a frame feature of a newly captured frame with the frame features stored in the feature storage; and
detecting a change of the capturing target based on a difference between the frame feature of the newly captured frame and the frame feature of the frame found in the searching step.

12. A video processing apparatus for detecting a change of a capturing target based on a video captured by a capturing unit whose capturing range changes, comprising:
a feature storage that stores a frame feature of each frame extracted from the captured video;
a frame searcher that searches for a frame, a frame feature of which is stored in said feature storage, having a capturing range matching a capturing range of the newly captured frame by comparing a frame feature of a newly captured frame with the frame features stored in said feature storage;
a change detector that detects a change of the capturing target based on a difference between the frame feature of the newly captured frame and the frame feature of the frame found by said frame searcher; and
a video accumulator that accumulates the video in which a change of the capturing target is detected by said change detector.

13. The video processing apparatus according to claim 12, further comprising a feature extractor that extracts a frame feature of each frame from the captured video,
wherein said feature storage stores the frame feature of the each frame extracted by said feature extractor.

14. The video processing apparatus according to claim 12, further comprising a feature receiver that receives a frame feature of each frame extracted from the captured video,
wherein said feature storage stores the frame feature of the each frame received by said feature receiver.

15. A control method of a video processing apparatus for detecting a change of a capturing target based on a video captured by a capturing unit whose capturing range changes, comprising the steps of:
storing a frame feature of each frame extracted from the captured video into a feature storage;
searching for a frame, a frame feature of which is stored in the feature storage, having a capturing range matching a capturing range of the newly captured frame by comparing a frame feature of a newly captured frame with the frame features stored in the feature storage;
detecting a change of the capturing target based on a difference between the frame feature of the newly captured frame and the frame feature of the frame found in said searching step; and
accumulating a plurality of frames including the frame where the capturing target has changed, which is detected in said detecting step.

16. A computer-readable storage medium storing a control program of a video processing apparatus for detecting a change of a capturing target based on a video captured by a capturing unit whose capturing range changes, the control program causing a computer to execute the steps of:
storing a frame feature of each frame extracted from the captured video in a feature storage;
searching for a frame, a frame feature of which is stored in the feature storage, having a capturing range matching a capturing range of the newly captured frame by comparing a frame feature of a newly captured frame with the frame features stored in the feature storage;
detecting a change of the capturing target based on a difference between the frame feature of the newly captured frame and the frame feature of the frame found in said searching step; and
accumulating a plurality of frames including the frame where the capturing target has changed, which is detected in said detecting step.

17. A capturing apparatus that includes a moving unit changing a capturing range and captures a video whose capturing range changes, comprising:
a capturing unit whose capturing range changes;
a feature extractor that extracts a frame feature of each frame from the video captured by said capturing unit; and
a selector that selects a video in which a capturing target changes in a same capturing range based on the frame features extracted by said feature extractor.

18. The capturing apparatus according to claim 17, wherein said selector comprises:
a feature transmitter that transmits the frame feature extracted by said feature extractor; and
a receiver that receives information representing a change of the capturing target returned from a transmission destination based on the transmission of the feature, and selects the video corresponding to the information representing the change of the capturing target received by said receiver.

19. The capturing apparatus according to claim 17, further comprising:
a feature storage that stores the frame feature of the each frame extracted by said feature extractor;
a frame searcher that searches for a frame, a frame feature of which is stored in said feature storage, having a capturing range matching a capturing range of the newly captured frame by comparing a frame feature of a newly captured frame with the frame features stored in said feature storage; and
a change detector that detects a change of the capturing target based on a difference between the frame feature of the newly captured frame and the frame feature of the frame found by said frame searcher,
wherein said selector selects the video corresponding to the change of the capturing target detected by said change detector.

20. The capturing apparatus according to claim 17, further comprising a transmitter that transmits the video selected by said selector.

21. The capturing apparatus according to claim 17, further comprising a video accumulator that accumulates the video selected by said selector.

22. A control method of a capturing apparatus that includes a moving unit changing a capturing range and captures a video whose capturing range changes, comprising the steps of:
extracting a frame feature of each frame from the video captured by a capturing unit whose capturing range changes; and
selecting a video in which a capturing target changes in a same capturing range based on the frame features extracted in said extracting step.

23. A computer-readable storage medium storing a control program of a capturing apparatus that includes a moving unit changing a capturing range and captures a video whose capturing range changes, the control program causing a computer to execute the steps of:
extracting a frame feature of each frame from the video captured by a capturing unit whose capturing range changes; and
selecting a video in which a capturing target changes in a same capturing range based on the frame features extracted in the extracting step.
